(19) United States
(12) Patent Application Publication
(10) Pub. No.: US 2007/0043682 A1
(43) Pub. Date: Feb. 22, 2007

(54) Point of sale product authorization

(75) Inventors: Michael Drapkin, Airmont, NY (US); Daniel Jitzchak Mayer, Warren, NJ (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: IDT CORPORATION

(21) Appl. No.: 11/477,221

(22) Filed: Jun. 29, 2006

Related U.S. Application Data
(63) Continuation-in-part of application No. 11/205,927, filed on Aug. 17, 2005.

(51) Int. Cl. G06Q 99/00

(52) U.S. Cl. 705/71

(57) ABSTRACT

A method for authorizing a sale of a product, comprising: sending a first key from a point of sale device to a key management system; determining if the first key is found in the key management system; determining whether the first key is associated with a valid merchant identifier and terminal identifier; and authorizing a sale at a point of sale of the product if the first key is found in the key management system and if the first key is associated with a valid merchant identifier and terminal identifier, wherein a purchaser receives a copy of a second key associated with the first key at time of purchase. The system has a Key Management System (KMS) with databases. The system also has a first key file and associated second key(s) file in said databases. The system also has an input device at a retail-outlet terminal that inputs an identifier during a sale at the point of sale, wherein the KMS compares the identifier with the first key file and key attributes to determine if the first key is found and if its associated attributes are favorable. The KMS permits or denies the sale of the product based on these attributes. The KMS subsequently permits or denies the installation of the product on target devices based on vendor rules and product attributes.

### CROSS-REFERENCED APPLICATIONS

This application is a continuation-in-part of U.S. patent application Ser. No. 11/205,927, filed on Aug. 17, 2005, which is incorporated herein by its entirety.

### BACKGROUND OF THE INVENTION

1. Field of the Invention

The present disclosure relates to an authorization of a product at a point of sale area, and more particularly, to an installation and activation of the product.

2. Description of the Related Art

Retailers sell product, such as software, either to specialized markets or the general public. One problem associated with retailing is that of “shrinkage”, i.e., the problem of an actual inventory being smaller than the inventory that should be on hand, according to the paperwork. Shrinkage can be the result of theft, or such other factors as accounting errors, damaged articles being discarded, and inventory errors.

Retail inventory shrinkage is a significant part of the retailer's overhead costs. Conventional solutions force the retailer to invest in inventory software to track shrinkage, because the retail product boxes have inherent value even prior to sale. Furthermore, conventional solutions require that valuable software be locked in secure cases in the retail store, requiring sales persons to summon a manager in order to unlock and retrieve the software product. In many cases, the product must then be physically and securely handled by store personnel until the sale has been completed at the point of sale, which is often some distance away from the secure case. Furthermore, the packaging containing the product is typically designed to be larger to aid theft prevention (i.e., harder to physically carry it out of a secured area). However, this larger packaging occupies a larger retail space, reducing the amount of product a retailer can display at any one time.

Therefore, there is a need to sell a product, such as software, that has no intrinsic value prior to sale, while reducing product handling overhead, such as is used in conventional retail operations.

### SUMMARY OF INVENTION

A method for authorizing the sale of a product to a purchaser, comprising: sending a key from a point of sale device to a management system managing at least one key; determining if the key is found in the management system; determining a status of the key according to sale-authorization criteria comprising at least one factor; authorizing the sale of the product at the point of sale device (i) if the key is found in the management system and (ii) if the status meets the sale-authorization criteria; and providing to the purchaser an enablement key associated with the key at time of purchase.

The sale-authorization criteria comprise at least one criteria selected from the group consisting of: (i) the point of sale device is valid for the key, (ii) the point of sale device is at a valid merchant for the key, (iii) the point of sale device is in permissible geographic or geopolitical regions for the key, (iv) the key status indicates the product was not yet sold, and (v) the key status indicates the product was not yet operationally enabled.

The enablement key is used for the operational enablement of the product.

A method of manufacturing a product in a package, comprising: generating a key; generating an associated enablement key; sending a copy of the key and the enablement key to a key management system; placing a copy of the key on the package; and encrypting and embedding a copy of the associated enablement key in the product. Further comprising embedding in the product a means for communicating with the key management system through a network. Further comprising embedding in the product a means for providing to the key management system the copy of embedded encrypted enablement key. Further comprising embedding in the product a means for enabling the product operation based on (i) communication with the key management system, and/or (ii) local entry of the enablement key, wherein local entry comprises at least one selected from the group consisting of: manual entry; voice entry; and entry from media connected to the product using wired or wireless connectivity. Further comprising placing the copy of the key so that the key is readable by at least one selected from the group consisting of: a point of sale device; a person; and a person assisted by a device.

A system for authorizing an online operational enablement of a product through employment of a key management system, comprising; a database having a key file and an enablement key file; a backend system with means for reading an enablement key embedded in the product during an online operational enablement session, wherein the backend system searches for the embedded enablement key in the enablement key file and denies the operational enablement if the embedded enablement key is not found in the enablement key file; wherein the key file further comprises: an acquired attribute; and an enabled attribute; wherein the backend system denies the operational enablement if the acquired attribute is set for negative for the key; wherein the backend system denies the operational enablement if the enabled attribute is set for positive for the key, wherein the backend system compares the embedded enablement key to the stored enablement key that correlates to the key; and wherein the backend system authorizes the operational enablement of the product if the stored enablement key correlates to the embedded enablement key and the backend system denies the authorization of the operational enablement of the product if the stored enablement key does not correlate to the embedded enablement key, wherein the embedded operational key is either encrypted or not encrypted.

The key file further comprises a geographic operational attribute; wherein the backend system denies the operational enablement of the product if the enablement is initiated from a physical or political region different from that defined by the geographic operational attribute; and authorizes operational enablement when the physical or political region is within the permissible range as defined by the geographic operational attribute.

The geographic operational attribute is populated from at least one data selected from the group consisting of: vendor data; distributor data; the geographic region of the authorized point of sale device; and data embedded in the product. The geographic region from which the operational enablement is initiated is determined from a network address.

A system for authorizing product activation at a point of sale comprising: a product repository database (PRD); a legitimate key file in the PRD; and an input device that inputs an identifier during a sale of the product; wherein the PRD compares the identifier with the legitimate key file to determine if the identifier is found in the legitimate key file; and wherein the PRD designates the found key in the key file as activated if the identifier is found in the legitimate key file. The PRD denies the sale if the identifier is not found in the legitimate key file and/or offers to sell the identifier so that the product can be legitimately activated. The legitimate key file is received from at least one database selected from the group consisting of: a vendor product database; and a distributor database. The PRD further comprises an activated key designation. The PRD compares the identifier to the activated key designation for on-line activation, wherein if the identifier in the key file is not designated as activated, the PRD activates the product; and if the identifier is found in the activated key file, the PRD does not activate the product. The key is designated as activated if the key is not already so designated. The identifier and the key have an exact correlation, and the product has intelligence. Optionally, the key is a unique key.

The intelligence comprises a least one selected from the group consisting of: encrypted or unencrypted version of an enablement key; a network address of the PRD; and means for communicating with the PRD. The input device has an associated retail outlet number.

The PRD further determines whether the associated retail outlet number is contained in a legitimate retail outlet file. The PRD further determines whether the associated retail outlet number is authorized to sell the product identified with the key.

The system further comprising a network coupled between the input device and the PRD, wherein the network comprises at least one selected from the group consisting of: packet-switched network; circuit-switched network; private line; an IP network; and wired or wireless transmission media.

Preferably the packaging of the product has an associated magnetic strip readable by the input device, wherein the key is contained within the associated magnetic strip. The input device is a credit card reading machine.

The system further comprising a radio frequency identifier (RFID) embedded in or on the product, wherein the RFID contains at least the key. The PRD enables the operation of the product based on the product intelligence when the product is online. The purchaser receives a copy of the enablement key at time of purchase. The purchaser inputs the copy of the enablement key to enable operation of the product when the product or a target device for the product is offline.

A method for authorizing an off-line operational enablement of a product comprising: receiving a key, which is either encrypted or non-encrypted, from a product repository database (PRD) at time of purchase; initializing an operational enablement of the product; inputting the key using the product; determining if the key matches against a product-embedded key, and if the key matches against the product-embedded key, enabling the operation of the product. The operational enablement is performed once for all subsequent product operations. The method further comprises checking an identifier key against a legitimate identifier key file before permitting the receiving step to proceed. The product comprises a device carrying content from the group of DVD, CD, flash memory, and the key enables the device from the group consisting of: a fixed number of uses, a fixed amount of time; and unlimited use. Optionally, at least one of the key and product-embedded key is a unique key.

A method of manufacturing a product, comprising: determining whether a key is to be embedded in the product and/or in the packaging of the product; embedding a device having the key if the key is to be embedded in the product; programming the key on a magnetic strip portion of the package, and/or into a device disposed in or on the package if the key is to be embedded in the packaging; sending a copy of the key to a legitimate key file; generating an enablement key; sending a copy of the enablement key to an enablement key file with association to the key; and encrypting and embedding the enablement key in the product. The method further comprises embedding the network address of a product enablement database in the product. The programming step further comprises printing the key so that the key can be optically read by at least one of: a point of sale device, and a human, when the product is in the package.

A method for manufacturing a product having two factor authentication, the method comprising: generating a key and an enablement key; encrypting the enablement key; embedding the encrypted enablement key into the product; printing the key and/or encoding a magnetic strip and/or programming an RFID and attaching to at least one selected from the group consisting of: package intended for the product, and the product itself; sending the key and the enablement key to a key management system; initializing key attributes as “not acquired” and “not enabled”; populating legitimate merchant identification and/or permissible product selling geography; and inserting the product with the key and/or enablement key into the package.

A method for purchasing a product comprising: sending a key disposed in and/or on the product or a packaging of the product to a key management system to determine if the key in the key management system has a key attribute of “not acquired”; if the key attribute is “acquired”, denying retail transaction; if the key attribute is “not acquired”, determining if the key arrived from a terminal of an authorized outlet in a correct geography; if authorized outlet is not in a correct geography, denying retail transaction; and if authorized outlet is in a correct geography, permitting the retail transaction and resetting key attribute to “acquired”.

The method further comprises: providing a purchaser of the product during the permitted retail transaction with an enablement key, wherein the enablement key enables the operation of the product when the product is not communicating to the key management system.

A method for online installation of a product having a key and an installation key, the method comprising: initiating the installation of the product on a target device; communicating an encrypted installation key disposed on or about the product to a key management system comprising a key file and an installation-key file; determining if the installation key is listed in the installation-key file; determining if the key is listed in the key file and if the key file indicates that the key comprises an “acquired” attribute and an “uninstalled” attribute; and permitting installation of the product on the target device if the key comprises the “acquired” attribute and the “uninstalled” attribute or preventing installation of the product on the target device if the key does not comprise either the “acquired” attribute or the “uninstalled” attribute.

The method further comprises the step of: if installation is permitted, updating the key management system such that the key acquires an “installed” attribute.

The method further comprises the step of: if the installation key is not listed in the installation-key file or if the key does not comprise either the “acquired” attribute or the “uninstalled” attribute, determining if a product profile permits exceptions; if no exceptions are permitted in the product profile, preventing installation of the product on the target device; or if exceptions are permitted in the product profile, permitting at least one action selected from the group comprising: remitting of payment to permit installation of the product on the target device; permitting installation of the product on a plurality of target devices; and requiring proof of prior uninstallation to permit installation of the product on the target device to proceed.

A method for offline installation of a product on a target device, the method comprising: inputting an installation key into the target device; determining if the inputted installation key corresponds to a previously encrypted installation key embedded in the product; and if inputted installation key does not correspond to the encrypted installation key, denying installation of the product on the target device; or if inputted installation key does correspond to the encrypted installation key, permitting limited-duration operation of the product on the target device.

The method further comprises: when the product operates on the target device, determining if the limited duration is in effect; if the limited duration is in effect, continuing operation of the product on the target device; if the limited duration nears expiration within a defined interval, perform one of the following steps; nothing, or alerting user to connect the target device online and register the product with the key management system; if the limited duration expired, causing at least one action selected from: disabling further operation of the product on the target device; connecting of target device online and registering the product; and remitting of payment to permit continued operation of the product on the target device. The registration may result in extension of the limited duration by an incremental interval, or in the elimination of the limited duration test.

A method of returning a product to a retailer comprising: scanning the product to determine if a key is present; communicating the key to a key management system; determining if the key management system includes attributes of the key comprising “acquired” attribute and “not activated” attribute; if either of the key attributes are not present, disallowing return of the product; if both key attributes are present, determining if the key was communicated from an authorized point of sale; if the key was not communicated from an authorized point of sale, disallowing return of the product; and if the key was communicated from an authorized point of sale, permitting return of the product. The permitting of return further ensures at least one condition selected from the group consisting of: that the key was communicated from an authorized point of sale within the same retail outlet from which the original purchase was made; that the return is attempted at an outlet of the same retail chain from which the original purchase was made; and that the return is attempted at a retail outlet within geographic boundaries authorized for selling the returned product; and disallowing return of the product if at least one condition is not met.

The method further comprises: after permitted return of the product, resetting key attribute of the first key to a “not acquired” attribute; and returning the product to inventory.

A method of transferring an installed product comprising: requesting that the installed product be uninstalled; downloading or enabling uninstallation verification means; uninstalling the product and activating the verification means; verifying that the product has been uninstalled; and if uninstalling cannot be verified, informing user of failure of uninstallation; or if uninstalling is verified, resetting a key attribute to “not installed” attribute. Preferably, the uninstallation verification means is a program or an applet.

A system for authorizing an online operational enablement of a product through employment of a backend system, comprising; a key management system; a database having a key file and an enablement-key file; an encrypted enablement key embedded in the product; a network coupling the product to the backend system; and means for providing the encrypted enablement key to the backend system via the network; wherein the backend system compares the enablement key with the enablement-key file to determine if the enablement key is found in the enablement-key file and denies the operational enablement if the enablement key is not found in the enablement-key file; wherein the enablement key is associated with a key in the key file; wherein the key further comprises: an acquired attribute; and an operationally enabled attribute; wherein the backend system denies operational enablement of the product if the acquired attribute is set for negative; wherein the backend system denies operational enablement of the product if the operationally enabled attribute is set for positive.

A computer readable storage media comprising executable computer program instructions which when executed cause a processing system to perform a method for authorizing the sale of a product to a purchaser, comprising: sending a key from a point of sale device to a management system managing at least one key; determining if the key is found in the management system; determining a status of the key according to sale-authorization criteria comprising at least one factor; authorizing the sale of the product at the point of sale device (i) if the key is found in the management system and (ii) if the status meets the sale-authorization criteria; and providing to the purchaser an enablement key associated with the key at time of purchase.

A computer readable storage media comprising executable computer program instructions which when executed cause a processing system to perform a method for authorizing an off-line operational enablement of a product comprising: receiving a key, which is either encrypted or non-encrypted, from a product repository database (PRD) at time of purchase; initializing an operational enablement of the product; inputting the key using the product; determining if the key matches against a product-embedded key; and if the key matches against the product-embedded key, enabling the operation of the product.

A computer readable storage media comprising executable computer program instructions which when executed cause a processing system to perform a method of manufacturing a product, comprising: determining whether a key is to be embedded in the product and/or in the packaging of the product; embedding a device having the key if the key is to be embedded in the product; programming the key on a magnetic strip portion of the package, and/or into a device disposed in or on the package if the key is to be embedded in the packaging; sending a copy of the key to a legitimate key file; generating an enablement key; sending a copy of the enablement key to an enablement key file with association to the key; and encrypting and embedding the enablement key in the product.

A computer readable storage media comprising executable computer program instructions which when executed cause a processing system to perform a method for manufacturing a product having two factor authentication, the method comprising: generating a key and an enablement key; encrypting the enablement key; embedding the encrypted enablement key into the product; printing the key and/or encoding a magnetic strip and/or programming an RFID and attaching to at least one of package intended for the product, or the product itself; sending the key and the enablement key to a key management system; initializing key attributes as “not acquired” and “not enabled”; populating legitimate merchant identification and/or permissible product selling geography; and inserting the product with the key and/or enablement key into the package.

A computer readable storage media comprising executable computer program instructions which when executed cause a processing system to perform a method for purchasing a product comprising: sending a key disposed in and/or on the product or a packaging of the product to a key management system to determine if the key in the key management system has a key attribute of “not acquired”; if the key attribute is “acquired”, denying retail transaction; if the key attribute is “not acquired”, determining if the key arrived from a terminal of an authorized outlet in a correct geography; if authorized outlet is not in a correct geography, denying retail transaction; and if authorized outlet is in a correct geography, permitting the retail transaction and resetting key attribute to “acquired”.

A computer readable storage media comprising executable computer program instructions which when executed cause a processing system to perform a method for online installation of a product having a key and an installation key, the method comprising: initiating the installation of the product on a target device; communicating an encrypted installation key disposed on or about the product to a key management system comprising a key file and an installation-key file; determining if the installation key is listed in the installation-key file; determining if the key is listed in the key file and if the key file indicates that the key comprises an “acquired” attribute and an “uninstalled” attribute; and permitting installation of the product on the target device if the key comprises the “acquired” attribute and the “uninstalled” attribute or preventing installation of the product on the target device if the key does not comprise either the “acquired” attribute or the “uninstalled” attribute.

A computer readable storage media comprising executable computer program instructions which when executed cause a processing system to perform a method for offline installation of a product on a target device, the method comprising: inputting an installation key into the target device; determining if the inputted installation key corresponds to a previously encrypted installation key embedded in the product; and if inputted installation key does not correspond to the encrypted installation key, denying installation of the product on the target device; or if inputted installation key does correspond to the encrypted installation key, permitting limited-duration operation of the product on the target device.

A computer readable storage media comprising executable computer program instructions which when executed cause a processing system to perform a method of returning a product to a retailer comprising: scanning the product to determine if a key is present; communicating the key to a key management system; determining if the key management system includes attributes of the key comprising “acquired” attribute and “not activated” attribute; if either of the key attributes are not present, disallowing return of the product; if both key attributes are present, determining if the key was communicated from an authorized point of sale; if the key was not communicated from an authorized point of sale, disallowing return of the product; and if the key was communicated from an authorized point of sale, permitting return of the product.

A computer readable storage media comprising executable computer program instructions which when executed cause a processing system to perform a method of transferring an installed product comprising: requesting that the installed product be uninstalled; downloading or enabling uninstallation verification means; uninstalling the product and activating the verification means; verifying that the product has been uninstalled; and if uninstalling cannot be verified, informing user of failure of uninstallation; or if uninstalling is verified, resetting a key attribute to “not installed” attribute.

The key further enables the device to be used in at one or more target devices selected from a group consisting of one target device; a specified number of target devices; an unlimited number of target devices; and target devices of specific types.

### BRIEF DESCRIPTION OF THE DRAWINGS

FIG. 1 is a system diagram of a product point of sale (POS) activation system.

FIG. 2 is a method of manufacturing a product with an activation key (e.g., first key) number and an embedded serial identifier (e.g., second key) (“serial ID,” such as numbers, letters, alphanumeric codes, and so on).

FIGS. 3 and 4 are a method for purchasing an activation key and a corresponding embedded serial id.

FIGS. 5 and 6 are a method for online activation of a product containing the activation key.

FIGS. 7 and 8 are a method for offline activation of a product containing the activation key.

FIG. 9 is a system diagram of a product point of sale (POS) activation system according to another embodiment of the present invention.

FIG. 10 is a method of manufacturing a product with the first key number and a second key number.

FIG. 11 is a method of purchasing the product.

FIG. 12 is a method of online product installation.

FIG. 13 is a method of offline installation.

FIG. 14 depicts method 1400 enabling in-store product returns.

FIG. 15 depicts method 1500 enabling product transfer by un-installing the product from one computer so that customer can re-install it on a new computer.

FIG. 16 is an illustration of a product package with a magnetic stripe, optically readable identification number, and an RFID.

### DETAILED DESCRIPTION OF THE PREFERRED EMBODIMENT

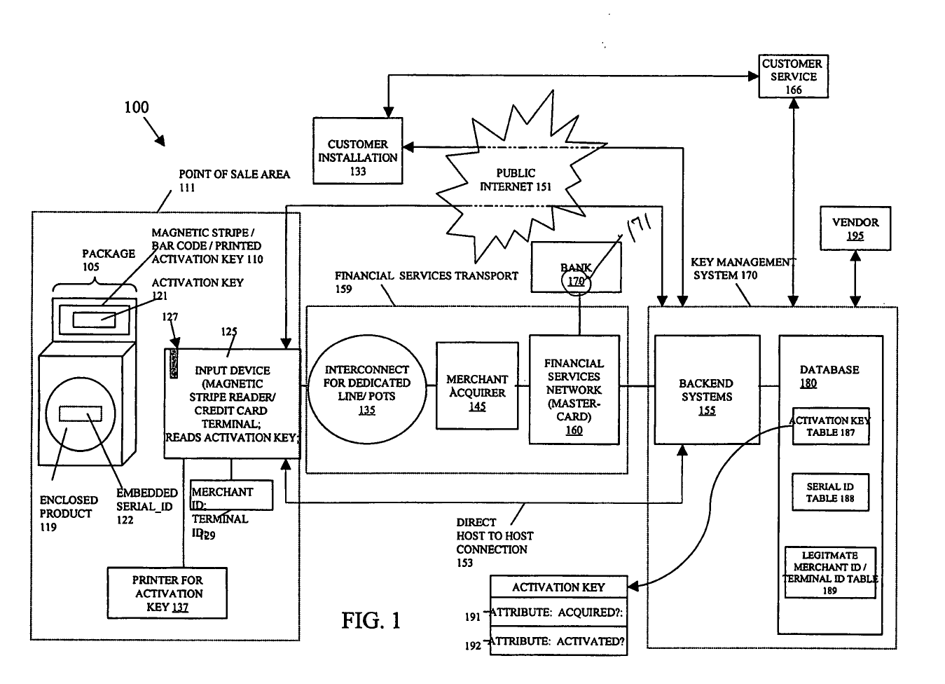

FIG. 1 illustrates a POS activation system (“system”) 100. System 100 has a point of sale area (POS) 111, a financial services transport 159, a direct host-to-host connection 153, a public internet connection 151, a key management system (KMS) 170, customer service 166, customer installation 133, and a vendor 195.

POS 111 has package 105. Package 105 has a magnetic stripe 110. An activation key 121 is found within magnetic stripe 110, and is generally visible or otherwise detectable without opening or otherwise compromising package 105, although magnetic stripe 110 can also be a bar code. Alternatively, activation key 121 is printed on package 105.

Generally, activation key 121 is used by KMS 170 to determine if a product 119, within package 105, was legitimately acquired. This determination occurs, for instance, when buying product 119 or installing product 119. In the present application, installing can also mean enabling. Product 119 can be generally defined as an article that has been manufactured that does not require continual service from a service provider to use the product. An example of product 119 is software. Magnetic stripe 110 can be alternatively, for instance, a bar code, or other related technologies that can be used in optical scanners or magnetic stripe readers.

Financial services transport (FST) 159 is coupled to POS 111. Generally, FST 159 acts as an interface between POS 111 and KMS 170. Alternatively, a direct host-to-host connection 153 also couples POS 111 and KMS 170. In yet another embodiment, a public Internet 151 is coupled between POS 111 and KMS 170. A customer installation 133 for installing product 119 is also coupled to public Internet 151. Any of these can be used for conveying activation key 121 or installing product 119, as will be detailed below.

In a first embodiment, a process of installation of product 119 occurs online using public Internet 151. A user of product 119 enters activation key 121 into product 119 at a time of installation, which sends it to KMS 170 to determine whether activation key 121 has already been activated by another user. If it is not in use, and activation key 121 is otherwise legitimately acquired, KMS 170 then checks a stored serial ID from a serial ID file 188 against embedded serial ID 122. If these values match, KMS 170 activates product 119. If these values do not match, KMS 170 does not activate product 119.

In a second embodiment, to activate product 119, the installation is desired to be performed offline. Therefore, the purchaser acquires via printer for activation key 137 a print-out of activation key 121 at time of sale in POS area 111. Then, when installing offline, the user contacts a customer service 166, which is coupled to KMS 170, and provides activation key 121, received from POS area 111. If activation key 121 passes the various tests associated with it (was it properly acquired, and so on, as will be detailed below), an offline code is conveyed to customer installation 133 by a customer service 166 to be used in the installation of product 119, correlating to a serial ID in serial ID file 188. This received offline code is compared by a serial ID comparator within product 119 to determine whether to install or not to install product 119.

Furthermore, although embedded serial ID 122 and offline code can be copies of one another, it is not necessary that they are so. Although there should be a correlation as determined by the serial ID comparator inside product 119, this relationship can be determined by, for instance, an encryption algorithm inside product 119 that examines an encrypted serial ID 122 and an encrypted offline code to see if they correlate. Since the activation key 121 on the package relates to the embedded serial ID 122 inside product 119, then KMS 170 can provide an offline code that correlates to the serial ID 122, whether encrypted or not.

Package 105 does not need to be kept in a separate, secure area. This is because, in system 100, product 119 cannot be initialized or activated without a user conveying activation key 121 to KMS 170, KMS 170 verifying that activation key 121 has been legitimately acquired and not yet activated, and product 119 either receiving an offline code against which to compare embedded serial ID 122 (offline scenario), or KMS 170 comparing the corresponding serial ID in serial ID file 188 to embedded serial ID 122 (online scenario).

Product 119 has intelligence. In other words, there is a degree of enablement that is necessary to occur for an installation to take place and for product 119 to be useful. If the installation does not occur, product 119 does not function properly, perhaps not at all.

More specifically, POS area 111 has an input device 125 with a reader 127. Input device 125 can be a credit card authorization terminal or a point of sale terminal or a cash register. Reader 127 can be, for instance, a magnetic stripe swipe reader. Input device indicia 129 is associated with input device 125. Input device indicia 129 are the merchant_ID (i.e., who the merchant is), and a terminal_ID (i.e., what is the terminal identifier of input device 125). A printer 137 for activation key 121 may also be coupled to input device 125, or integrated into input device 125.

Input device 125 is coupled to an interconnect 135 of FST 159. Interconnect 135 can be a dedicated line, a plain old telephone system (POTS) connection, or some other connection. Interconnect 135 is coupled to a merchant acquirer 145.

Generally, merchant acquirer 145 acts as a switch for various types of financial transactions. In other words, merchant acquirer 145 receives retailer credit card transactions, and then aggregates the orders and determines what type of credit card or debit card it is, and then passes the order on to the appropriate bank 171 via financial services network 160, while taking a fee for the transaction.

For instance, in system 100, financial services network 160 sends transactions either to KMS 170, retailers or banks 171. If activation key 121 is received by financial services network 160, activation key 121 is routed to KMS 170.

KMS 170 has backend systems 155 and a database 180. Generally, backend systems handles database 180, and other interface needs of KMS 170, along with interactions with vendor 195, customer installation 133 and transactions from point of sale area 111.

Database 180 has a legitimate activation key file 187, a serial ID file 188, and a legitimate merchant ID/terminal ID file 189 (“merchant file 189”). Activation key file 187 has an “acquired” attribute 191, an “activated” attribute 192.

Database 180 is also coupled to vendor 195. Database 180 receives activation key file 187, serial ID file 188, and merchant file 189 from vendor 195. Furthermore, database 180 updates vendor 195 when attributes 191-192 of activation key file 187 are set.

Generally, backend systems 155 uses the data in database 180 to determine, as will be explained below, whether a received value that is being presented as activation key 121 input device 125 is a legitimate activation key 121, as compared against activation key file 187. If activation key 121 is legitimate (i.e., it is found in the file), then attribute 191 of activation key 121 is set to a positive “acquired,” within activation key file 187, and the user may finish the purchase of the product.

In order to accomplish this, backend systems 155 compares allowable activation keys in activation key file 187 with a received activation key 121 from POS area 111 to determine if there is a match. If there is a match, then activated attribute 192, and merchant ID terminal ID 129 and legitimate merchant ID/terminal ID file 189 are compared and/or determined, as will be described below. If all attributes check, then the retailer user of input device 125 is so notified and the sale is allowed to complete and “acquired” attribute 191 is set to positive. If not, the sale is blocked by database 180, as the activation key 121, received from input device 125, does not match an allowable activation key within legitimate key file 187 or the merchant ID terminal ID 129 is not valid or the other attributes 191-192 do not allow the sale to continue.

In one embodiment, it is also determined whether activation key 121 originates from a proper retail outlet, as determined by a comparison between merchant ID/terminal ID 129 and an entry in activation key file 187 corresponding to merchant file 189. If activation key 121 does not originate from an authorized retail outlet, the point of sale product activation fails. Legitimate retail outlet file 189 is received from vendor 195.

In the first embodiment of online activation, customer installation 133 contacts key management system 170 to activate product 119. Key management system 170 either grants or denies permission for this. This determination is performed by testing the newly-received activation key 121, conveyed from customer installation 133, against activation key file 187, both for existence, a positive acquired attribute 191, and for a negative activation attribute 192.

If activation key 121 is not found in activation key file 187, then product 119 is not legitimate, and installation/activation of product 119 is denied. If activation key 121 is found as having a negative acquired 191 attribute, then product 119 was not legitimately purchased, and installation/activation of product 119 is denied. However, even if activation key 121 is in activation key file 190 and attribute acquired 191 is positive, if activation key 121 is found as having a positive activation attribute 192 within activation key file 187, that activation key 121 is therefore already installed, and KMS 170 denies the activation. If attribute activated 192 is negative, KMS 170 allows the installation and/or activation to continue. This occurs by KMS comparing its serial ID file 188 to embedded serial ID 122 to determine if there is a match. If there is a match, installation continues.

KMS 170 then also toggles activation attribute 192 for activation key 121 into positive for activated activation key status file 192, as this key is now activated. This positive acquisition status 192 is then to be compared against further activations of products through use of received activation keys 121.

In the second embodiment of offline activation, when a purchaser purchases product 119 and contacts customer service 166 and supplies activation key 121, backend systems 155 determines, through a comparison of activation key 121 to activation key file 187, if activation key 121 is in activation key file 187. It also checks the acquired attribute 191, activated attribute 192, to see if product 199 was properly acquired and whether it was already activated. If not then activation fails. Backend systems 155 determine what the corresponding serial ID 122 is for activation key 121 through accessing serial ID file 192.

KMS 170 then generates an offline code as a function of the corresponding serial ID 122 stored in serial ID file 188, and conveys this offline code to customer installation 133, so that offline code can be entered into product 119 and can activate product 119 by the user offline. Product 119 then checks to see if the offline code correlates to embedded serial ID 122. If it does, installation continues. If it does not correlate, installation stops.

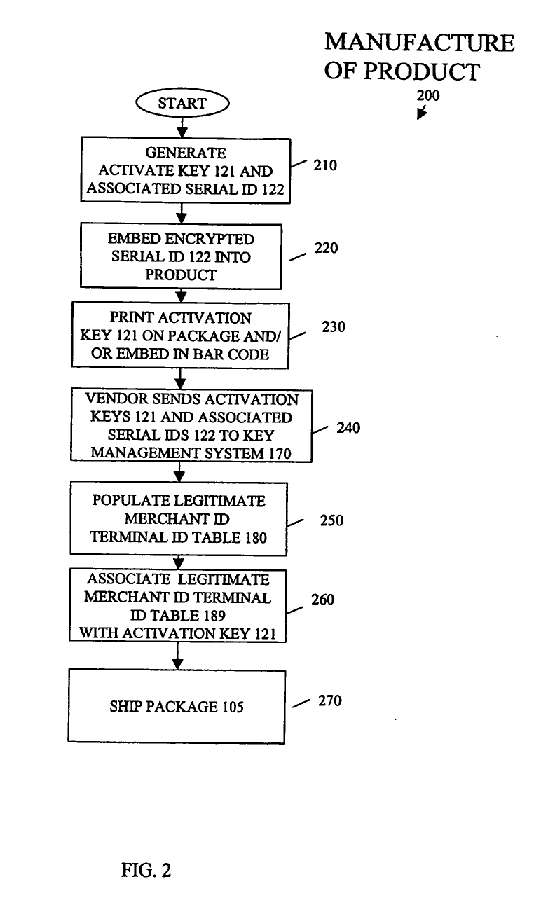

FIG. 2 is an illustration of a method 200 for manufacturing product 119 with magnetic stripe 110. Activation key 121 can be randomly generated. Method 200 places activation key 121 on package 105.

After starting, in step 210, activation key 121 and an associated embedded serial ID are generated. Method 200 advances to step 220.

In step 220, the vendors encrypt serial ID and embed as embedded serial ID 122 into product 119, such as a CD. Step 220 then advances to step 230.

In step 230, activation key 121 is embedded in magnetic stripe 110 or printed on outside of box 105. Step 230 then advances to step 240.

In step 240, vendor 195 sends activation key 121 from vendor products database 185 to activation key file 187 in database 180. Vendor 195 also sends the associated serial ID to serial ID file 188. Step 240 advances to step 250.

In step 250, merchant file 189 is populated by vendor 195. Method 200 advances to step 260.

In step 260, entries in merchant file 189 are associated with activation key 121. Method 200 advances to step 270.

In step 270, package 105 is shipped. Method 200 ends.

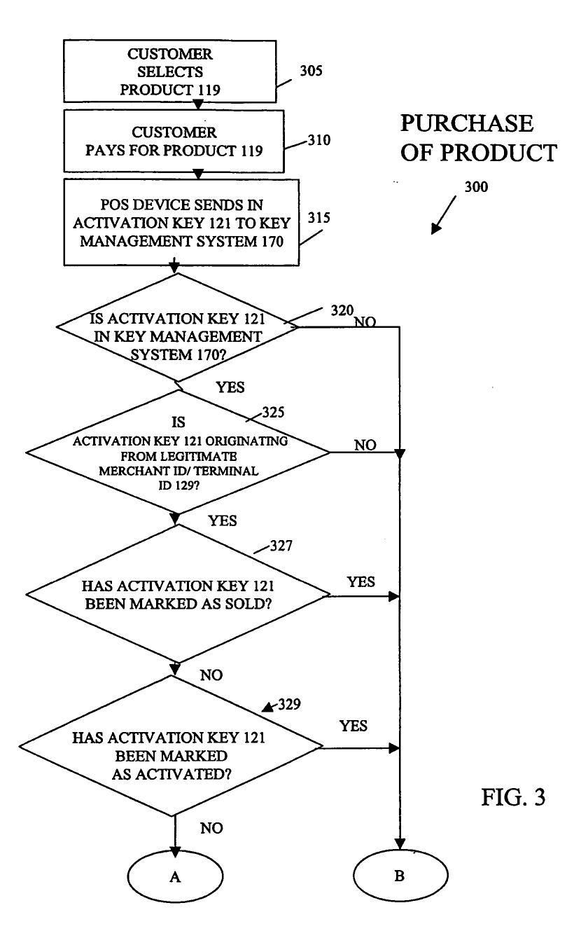

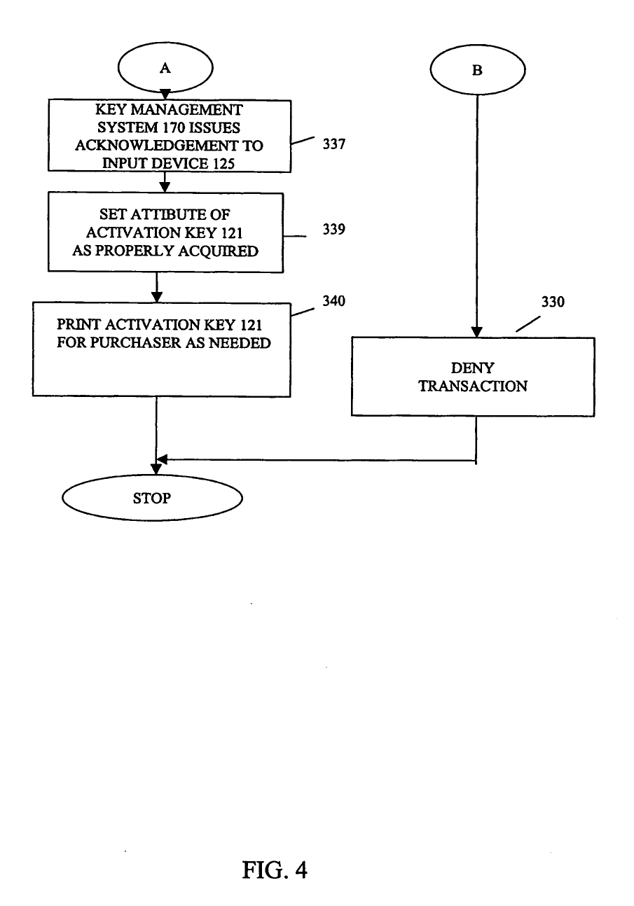

FIGS. 3 and 4 illustrate a method 300 for point of sale purchase of product and determining whether product 119 having activation key 121 should be sold by a retailer, based upon accessing legitimate activation key file 187. Generally, method 300 compares received activation key 121 to entries in activation key file 187 to determine whether a sale of product 119 should or should not take place.

In step 305, a customer selects product 119 having activation key 121. The selection is typically made off the shelf, with no extra security measures needed, as KMS 170 has to confirm the acquired 191 attribute in activation key 121 in order to allow an installation of product 119. Method 300 then advances to step 310.

In step 310, the customer pays for product 119. Method 300 advances to step 315.

In step 315, POS 125 sends activation key 121, read from magnetic stripe 110 to KMS 170. Furthermore, in step 315, input device 125 also conveys merchant ID/terminal ID 129. This can occur over public Internet 151, FST 159, or direct host-to-host connection 153, or other conveyance technologies. Step 315 advances to step 320. Alternatively, an intermediate retailer (not illustrated) can also be employed to convey activation key 121.

In step 320, it is determined by backend systems 155 whether activation key 121 is an allowable activation key by determining if activation key 121 corresponds to an entry in activation key file 187. If activation key 121 is not in activation key file 187, step 320 advances to step 330, and purchase is denied. If activation key 121 is in activation key file 187, method 300 advances to step 325.

In one embodiment, in step 325, it is determined if activation key 121 is received from an authorized reseller. This is performed by comparing merchant ID/terminal ID 129 with an entry in legitimate merchant ID/terminal ID file 189 associated with activation key 121. If input device 125 is associated with an authorized reseller, step 325 advances to step 335. Otherwise, step 325 advances to step 330, and purchase is denied.

In step 327, it is determined if acquired attribute 191 is already positive. If it is, method 300 advances to step 330 and transaction is denied. Otherwise, method 300 advances to step 329.

In step 329, it is determined if activation attribute 192 is already positive. If it is, method 300 advances to step 330 and transaction is denied. Otherwise, method 300 advances to step 337.

In step 337, an acknowledgement of the sale is sent to the retailer, the controller of input device 125, that the sale is acceptable to KMS 170 as determined through accessing activation key file 187. Method 300 advances to step 339.

In step 339, activation attribute 192 is set as positive. Method 300 advances to step 340.

In step 340, activation key 121 is printed for purchaser as needed (i.e., if activation key 121 is embedded in a bar code, etc.). For example, activation key 121 may get printed on a sales receipt. Method 300 then ends.

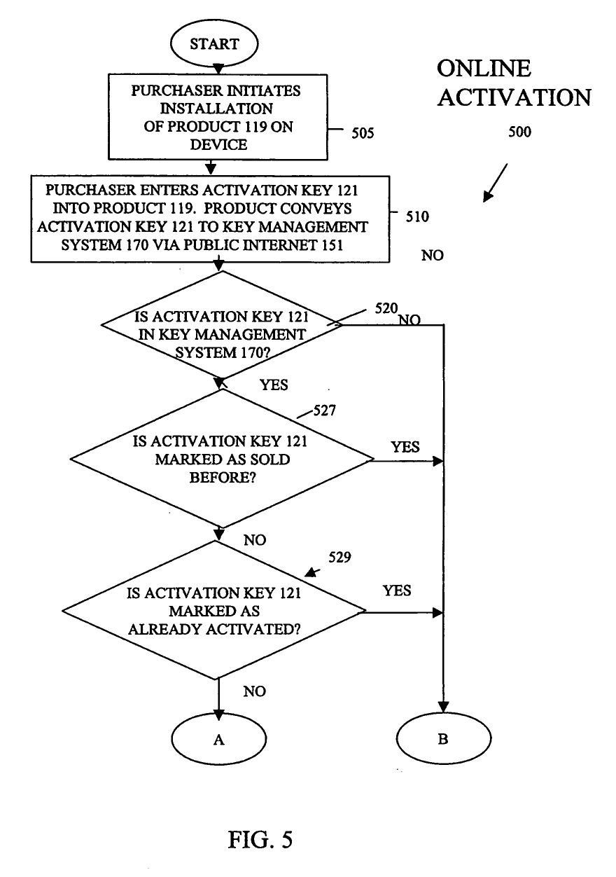

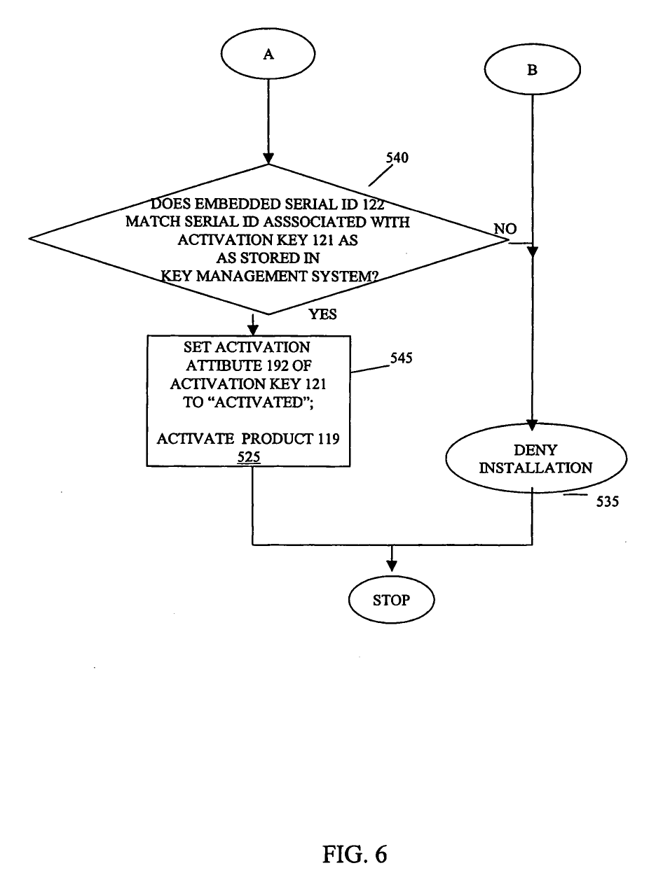

FIGS. 5 and 6 illustrate a method 500 for online activation or initialization of product 119 over the Internet. Generally, method 500 determines whether activation key 121, this time received by KMS 170 during installation/activation, is found in activation key file 187, and if so, does it have a positive acquired attribute 191, but a negative activated attribute 192. If this condition is not met, database 180 denies activation/installation. It also checks to see if product 119 has been properly acquired and if it has already been activated, and that serial ID in serial ID file 188 associated with activation key 121 matches embedded serial ID 122.

In step 505, purchaser begins to install product 119 on a device, such as a home PC, at customer installation 133. Step 505 advances to step 510.

In step 510, the purchaser, during the initiation of the installation/activation process at customer installation, enters activation key 121 into product 119, which conveys activation key 121 to KMS 170, such as through public Internet 151. Step 510 advances to step 520.

In step 520, database 180 determines if conveyed activation key 121 is found in activation file 187. If it is not, step 515 advances to step 535, and method 500 stops, and activation/installation is denied. If activation key 121 is found in activation file 187, then step 515 advances to step 527.

In step 527, it is determined if acquired attribute 191 is already positive for activation key 121. If it is, method 500 advances to step 535 and installation is denied. Otherwise, method 500 advances to step 529.

In step 529, it is determined if activated attribute 192 is already positive. If it is, method 500 advances to step 535 and installation is denied. Otherwise, method 500 advances to step 540.

In step 540, KMS 170 queries embedded serial ID 122 to determine if it matches a serial ID associated with activation key 121 and stored in serial ID file 188. If it does, method 500 advances to step 534. If it does not, method 500 goes to step 535, and denies installation.

In step 545, database 180 sets activation attribute 192 to positive, and activated product 119. Product is allowed to be activated at customer installation 133. Method 500 ends.

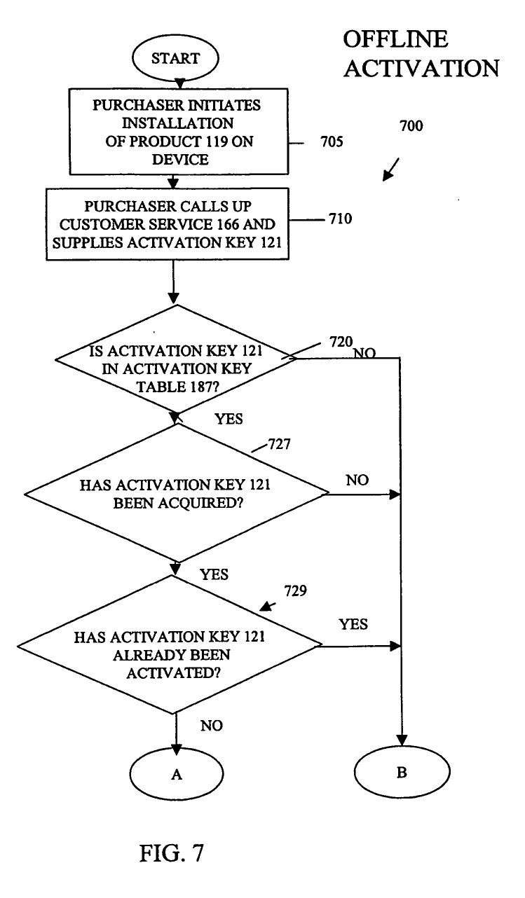

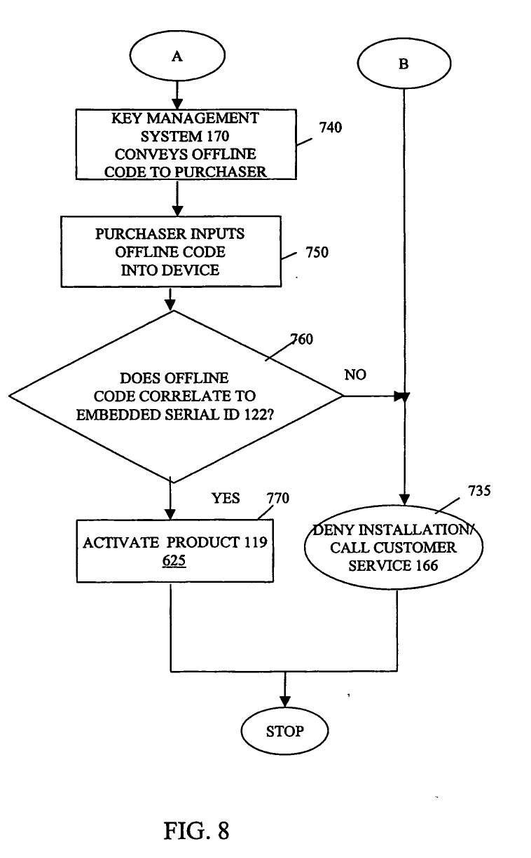

FIG. 7 illustrates a method 700 for activating product 119 without the use of the Internet or other online connection by consumer installation 133 to key management system 170. Generally, method 700 determines whether activation key 121, conveyed to customer service 166 by phone during installation/activation, is found in activation key file 187, and if so, does it have a positive acquired attribute 191, but a negative activated attribute 192. If this condition is not met, database 180 denies activation/installation. It also checks to see if product 119 has been properly acquired and if it has already been activated, and that serial ID in serial ID file 188 associated with activation key 121 matches embedded serial ID 122.

In step 705, purchaser begins to install product 119 on a device, such as a home PC. Step 705 advances to step 710.

In step 710, the purchaser, during the initiation of the installation/activation process at customer installation, calls up customer service 166 and supplies activation key 120. Step 710 advances to step 720.

In step 720, backend systems 155 determines if conveyed activation key 121 is found in activation file 187. If it is not, step 720 advances to step 735, and method 700 stops, and activation/installation is denied. If activation key 121 is found in activation file 187, then step 720 advances to step 727.

In step 727, it is determined if acquired attribute 191 is positive for activation key 121. If it is not, method 700 advances to step 735 and installation is denied. Otherwise, method 700 advances to step 729.

In step 729, it is determined if activated attribute 192 is already positive. If it is, method 700 advances to step 735 and installation is denied. Otherwise, method 700 advances to step 740.

In step 740, customer service 166 supplies offline code to purchaser. Activation key 121 attribute 192 activated is set to true. Method 700 advances to step 750.

In step 750, purchaser enters offline code into enclosed product 119. Method 700 advances to step 760.

In step 760, product 119 determines if offline code correlates with embedded serial ID 122. If it does, method 700 advances to step 770. If it does not, method 700 goes to step 735, and denies installation.

In step 770, product 119 is activation and installation proceeds. Method 700 ends.

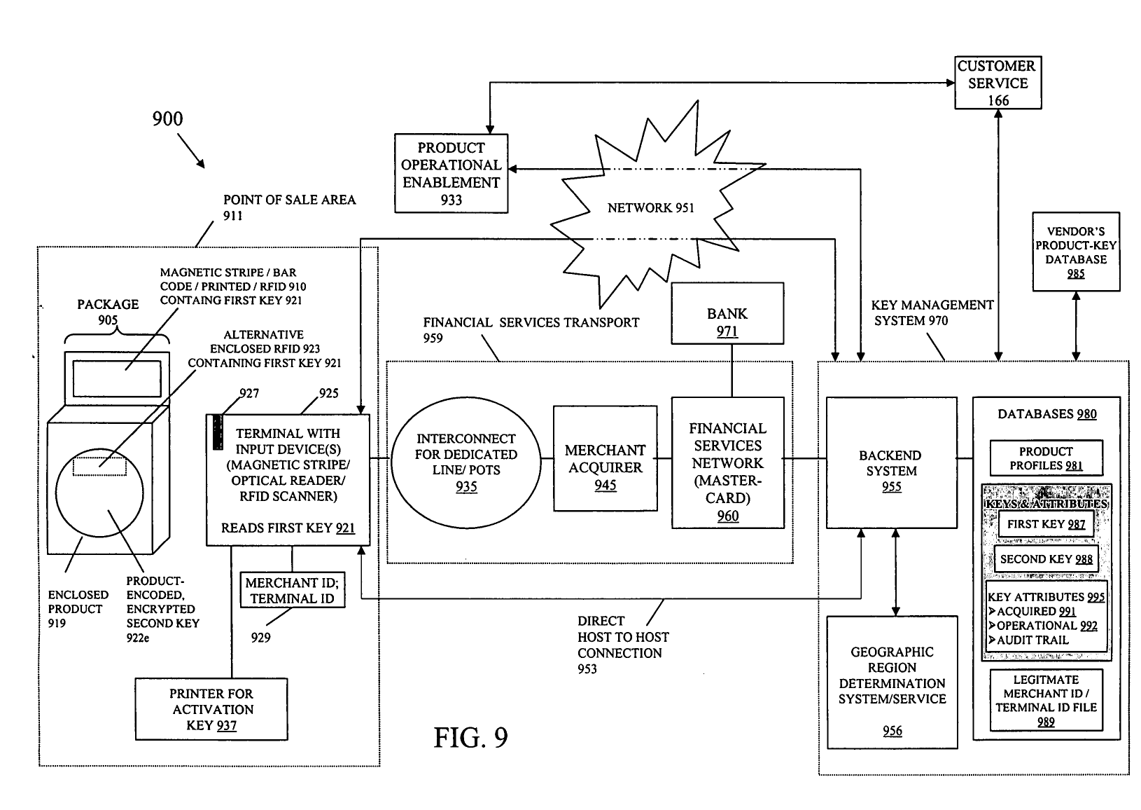

FIG. 9 illustrates a POS activation system (“system”) 900. System 900 has a package 905. Package 905 has a magnetic strip 910, a first key 921, and a product 919. First key 921 is used by system 900 to determine if product 919 was legitimately acquired when buying product 919 or installing product 919 on-line. In the present application, installing can also mean enabling. First key 921 can be embedded either in a radio frequency identifier (RFID) 923 instead or magnetic strip 910 or bar code or printed on the package in machine and/or human-readable form. First key 921 is readable from the outside of package 905; when read manually or optically, the first key may be printed on the outside of the package.

Product 919 has an encoded, encrypted second key 922e. In a first embodiment, before the customer installs the product on a target device (e.g., a personal computer) or otherwise activates the product, the target device sends encrypted second key (922e designates that encrypted second key) to KMS 970 to establish that the key attributes are favorable to installation (“acquired” and “not installed”). If the attributes are unfavorable, the customer is denied installation of product 919. If the attributes are favorable, KMS 970 permits the installation to complete.

In a second embodiment, product 919 can be installed offline. Generally, second key 922 is used for installing product 919 off-line. Second key 922 is embedded and encrypted within product 919. Typically, in order to activate product 919, the customer enters second key 922 into product 919, the code matches or correlates to encoded, encrypted (or otherwise unavailable to the customer) second key 922e. An unencrypted version of the second key 922 is provided by Key Management System (KMS) 970 to the purchaser at the time of purchase so that the customer (not necessarily the original purchaser) at a later time can install/activate product 919 off-line.

Product 919 has intelligence. In other words, it contains an encrypted version of second key 922, which is necessary for its installation. In system 900, product 919 is software, although other products can be substituted. “Intelligence” may also contain the network address and the programmatic content through which product 919 may obtain permission for online operational activation.

System 900 has a point-of-sale area 911, within which there is terminal 925 with a reader 927. Reader 927 can be, for instance, a manual keyboard, a magnetic swipe reader, an optical scanner, or an RFID reader. Terminal 925 is coupled to an interconnect 935. Interconnect 935 can be a dedicated line, a network (e.g., Internet) connection, a plain old telephone system (POTS) connection, a wireless system or some other connection. A printer 937 for second key 922 (or a number or alphanumeric string associated with second key 922) is also coupled to interconnect 935. Interconnect 935 is typically coupled to a merchant acquirer 945.

Generally, merchant acquirer 945 acts as a gateway for various types of financial transactions. In other words, merchant acquirer 945 receives retailers and wholesalers transactions, and then determines which bank(s) 971 they are addressed to, then routes the transactions via the appropriate financial services network 960, and ensures the transaction ends up at the appropriate destination. For instance, in system 900, transactions may be directed through the Mastercard® financial services network to Bank 971, or to KMS 970 depending on the routing code attached to the transaction at the point of sale 911. When financial transactions are completed (either as a card transaction via this network or as a cash transaction), the activation related transaction (starting with a message carrying first key 921) are routed between terminal 925 and to key management system 970.

KMS 970 has processing and communicating components in backend system 955, and databases 980 for (i) the first 987 and second 988 keys, with activation attributes 995, (ii) product profile 981, which includes product rules determined by the product vendor (including, e.g., geographic distribution and/or operational enablement limits), (iii) associations between legitimate merchant IDs and authorized terminal IDs 989, and (iv) an audit trail reflecting the date and type of every transaction occurring with respect to each key-assigned product 919. Databases 980 are also coupled to a vendor product key database (VPD) 985. Databases 980 populates first key file 987 with allowable first keys and populates second key file 988 with associated second keys, both received from VPD 985. Databases 970 maintain an association of each first key with one or more second keys. VPD 985 also populates product profile file 981.

In another embodiment, key management system 970 also has a geographic region determination system/service 956. This KMS embodiment enables the vendor to limit the geographical or political region (i) in which product instances (individually identified by first/second keys) or product classes (e.g., with common standard Universal Product Codes) may be sold, and/or (ii) from which product operations may be enabled when the product is online. Rules related to product sale and/or operational enablements are preferably populated from vendor's product database 985, or from other sources. In a possible embodiment, the geography of the product's operational enablement is determined by the geography of product sale. The geographic region determination system/service 956 may use the network address from which the product operational enablement is initiated to enforce geographic operational enablement rules. When 956 refers to a service, such service may be provided commercially by others.

KMS 970 behaves, for each product type, according to product-vendor rules, which reside in product profile 981. Generally, KMS 970 determines, as will be explained below, whether received value that is being presented as first key 921 is a legitimate first key, as compared against legitimate first key file 987. If first key 921 is legitimate, then an attribute corresponding to first key 921 is set to “acquired,” within first key file 987, and the customer may finish the purchase of the product. KMS 970 compares the file of allowable first keys in file 987 with the received first key 921, to determine if there is a match. If there is a match, then the merchant clerk using terminal 925 is so notified, the sale is allowed to complete and the attribute “acquired” is set in first key file 987. If not, the sale is blocked by KMS 970, as the first key 921, received from terminal 925, does not match an allowable first key within first key file 987; if acquired attribute is already set when the transaction arrives, the sale is blocked as above (with the exception of a “return” transaction described later)

In one embodiment, it is also determined whether first key 921 originates from a proper retail outlet, as determined by a comparison between legitimate merchant ID and/or terminal ID 989 and the ID(s) attached to the first-key message that is part of an activation session. If first key 921 does not originate from an authorized retail outlet, the sale is disallowed. Legitimate retail outlet file 989 is originally populated by the product vendor or distributor from VPD 985.

In the first embodiment, of on-line installation, the customer inserts the product into the target device (e.g., a PC); upon installation initiation 933 the product causes the target device to communicate with KMS 970 via network 951 (e.g., public or private Internet), sending it the encrypted second key 922e that was programmed into the product; KMS 970 either grants or denies permission for installation. This determination is performed by testing the received encrypted second key 922e to ascertain that (i) such second key 922 exists in file 988, and that (ii) the associated attributes in file 995 designate “acquired”, and “not operational”.

If second key 922 is not found in file 988, or the associated first key in file 987 does not possess the proper attributes, then the installation of product 919 is denied. Advantageously, KMS 970 may permit installation after advising the customer of the denial, and triggering a customer session designed to obtain remittance of the required fee (e.g., through a credit or debit card); after such remittance session, KMS 970 populates the required databases and credits the vendor with another product sale (albeit through an illegitimate sales channel).

In the second embodiment, when a customer purchases product 919 and KMS 970 first determines, through a comparison of first key 921 that the correct attributes are present for purchase approval, KMS 970 then determines the second key 922 corresponding to the received first key 921, and conveys that second key 922 from second-key file 988 to printer 937; the customer receives a printed copy of second key 922 at the point of sale upon payment for product 919. Second key 922 can subsequently be entered by the customer for off-line installation, in which the product will compare it with the encrypted second key 922e that was preprogrammed into it during production; offline installation is then permitted by the product in a manner similar to standard software installation In a further embodiment, a number is printed by printer for second key 937 that is different from second key 922, but is used in combination with second key 922 to install product 919. Subsequent to offline operational enablement, when the target device is first linked to an appropriate network (e.g., the Internet), the operational product communicates to KMS 970 so that “operational” can be appropriately registered as an attribute of the keys in databases 980; if no such communication occurs for an established time period, the product forces such online session to occur or disables itself until the session occurs.

In another embodiment, the vendor's product-key database may specify that both first and second keys be provided upon registration; in such cases, the product supplies the encrypted second key 922e, while the customer enters the first key based on packaging and/or product-borne information.

In a preferred embodiment, products activated at the point of sale for future operational enablement combine both online and offline methods. When the customer is provided with a printed copy of the second key 922, he may subsequently install the software either online or offline, without the need to commit to one or the other a-priori. Advantageously, this results in a single type of product and a single sales process, avoiding unnecessary inventory costs and operational complexity.

As discussed above, VPD 985 sends entries for legitimate first key file 987 to KMS 980 so that KMS 980 can populate first key file 987 with the attributes of “not acquired” and “not operational”. In this embodiment, databases 980 also receive from VPD 985 entries for associated second key(s) file 992.

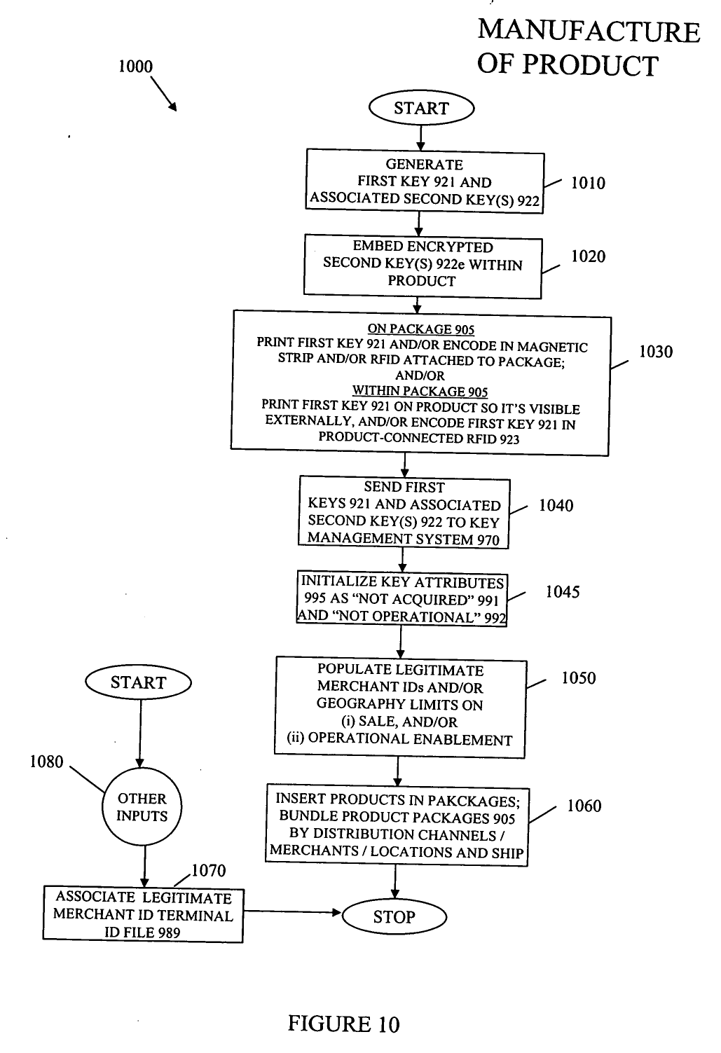

In a further embodiment, VPD 985 also populates and/or associates legitimate merchant IDs with specific first keys 920, thus enabling the product vendor to limit the merchant outlets through which specific product instances can be sold. The population and association of terminal IDs and Merchant IDs 989 is populated and edited by distribution channels, merchants, and/or merchant acquirers as needed for control and fraud-elimination purposes; appearing as input 1080 in FIG. 10, these are done through authenticated interfaces (including secure website interfaces) with well-defined role limits in obvious ways not shown or discussed further here.

In a further embodiment VPD also populates and/or associates legitimate merchant IDs with geographical designations, thus controlling the geographical (and thus political) boundaries of legitimate product sales. For example, local authorities might issue regulations that force vendors to control the distribution of certain products (e.g., game software) within their boundaries.

FIG. 10 is an illustration of a method 1000 for manufacturing, packaging, and shipping product 919 with magnetic strip 910, RFID 923, or other methods described before. Generally, method 1000 places first key 921 either in product 919 (e.g., when using an RFID embedded in the product) or on package 905 (such as externally-readable visible code or magnetic strip). When first code 921 appears (or is magnetically encoded) on the outside of the package, there is a need to ensure that each package matches the precise instance (not only product type) of the product packed within it.

In a preferred embodiment, first key 921 is attached to the product (e.g., printed on for reading/scanning through a transparent window in the package, or encoded in an RFID attached to the product) or is an integral part of the product itself (e.g., an RFID embedded in the material of the media—CD or DVD—carrying the product). In this embodiment, there is no need to maintain a correlation between the package and the product through the packaging process; maintaining such correlation is labor intensive and error prone. Advanced RFID tags are capable of holding and communicating a sufficient amount of information to uniquely identify product instances (e.g., first key as described herein), and not only product type (e.g., UPC code).

In a further embodiment, method 1000 generates one or more second key(s) 922, associates with each generated first key 921. Second key 922 (or a derivative thereof) is also encoded within product 919, to enable subsequent product installations. Multiple second keys 922 generated and encoded enable multiple subsequent installations of a single product. In this way, the vendor may define the number of times that a product may be installed (e.g., software licensed for 100 seats), and even control the number of times that a product can be legitimately resold among buyers (e.g., on eBay).

After starting, in step 1010, the vendor generates first key 921 and associated one or more second keys 922. This may be a batch function, generating multiple keys and associations before moving to the next step.

In step 1020, the vendor embeds the one or more encrypted second keys 922e within the medium carrying the product (e.g., as part of software embedded in CDs or DVDs).

In step 1030 the vendor places first key 921 on the package 905 and/or within package 905. More specifically, on the package 905, first key 921 may be printable and/or encoded in a magnetic strip and/or encoded in a package-affixed RFID. Alternatively or additionally, first key 921 may be printed on the product itself so that it is visible/readable through a transparent window package, and/or encoded in product-connected or product-embedded RFID residing inside the package. A product-embedded RFID may constitute an integral part of the material from which the product is constructed, and on which the product (e.g., software) is written. Step 1030 then advances to step 1040.

In step 1040, the vendor populates the databases in KMS 970 with the first keys and associated second keys; and in following step 1045 the associated key attributes 995 are initialized to “not acquired” 991 and “not operational” 992; the process advances to step 1050.

In step 1050, the vendor (or any authorized entity in the distribution channel) populates legitimate merchant IDs and or geographical rules into file 989 in KMS 980. Separate geographic rules may apply to legitimate locations of sale and legitimate locations of operational enablement. Step 1050 can be associated with specific product instances (e.g., with specific keys) or with generic products (regardless of the associated keys); the process advances to step 1060.

In step 1060, the vendor packs the product 919 within package 905. Placing first key 921 within the package enables the package to be generic, not requiring association with a specifically keyed product. Method 1000 then stops.

Step 1070 is asynchronous with the sequence of method 1000, since it is an ongoing process that identifies the association of legitimate merchant IDs with specific terminals capable of activating the products. Additionally, separate entities, such as the merchants themselves (“other inputs” 1080), may have responsibility for defining the terminals/merchant association.

In a further embodiment, product 919 is rental movies in a DVD, and second key 922 is used as a way to enable the playing of product 919. In a still further embodiment, key 922 has a limited shelf life, and is then updated/renewed, with a further payment by a consumer.

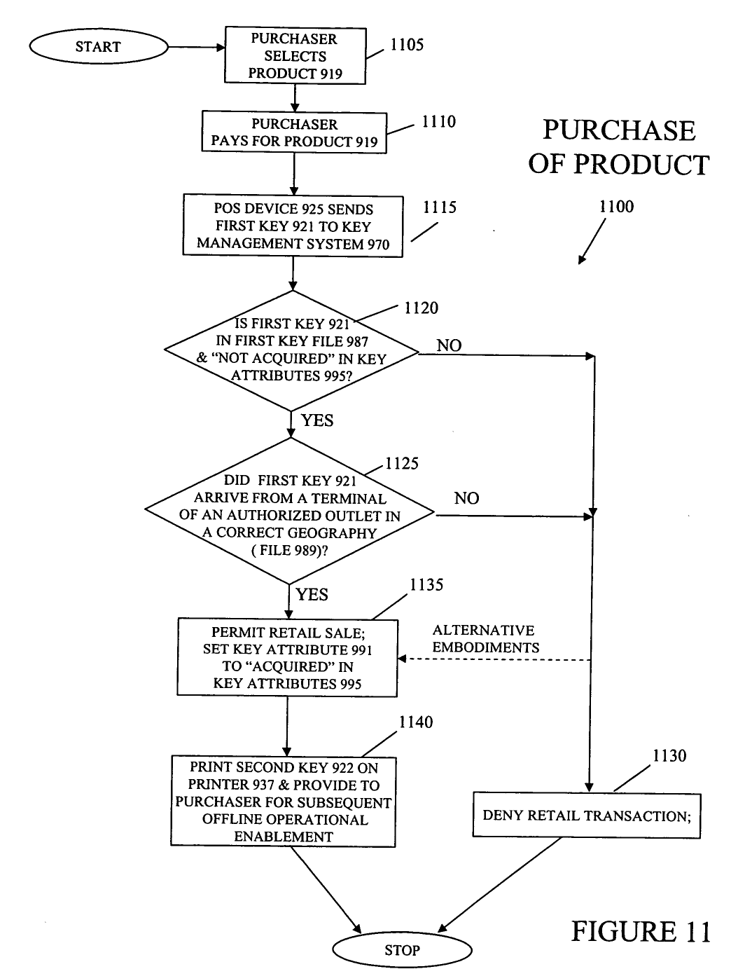

FIG. 11 illustrates a method 1100 for determining whether product 919 should be sold by a vendor, based upon accessing first key file 987. Generally, method 1100 compares first key 921 to entries in key file 987 to determine whether a sale of product 919 should or should not take place.

In step 1105, a customer selects product 919. The selection is typically made off the shelf, with no extra security measures needed, as KMS 970 has to confirm the first key 921 in order to allow an installation of product 919 and convey second key 922 to the customer. Method 1100 then advances to step 1110.

In step 1110, the customer pays for product 919. Method 1100 advances to step 1115.

In step 1115, POS 925 sends first key 921, read from magnetic strip 910 or RFID 923, over interconnection 935, to be conveyed to KMS 970. In cases where POS 925 features diverge, the first key may be read optically (alphanumeric code or bar-code), or entered manually through a keyboard. In general, the code identifies both product 919 type (such as software or movie, the title, the vendor, the version, and so on) and the specific instance of this particular product. Step 1115 advances to step 1120.

In step 1120, it is determined by KMS 970 whether first key 921 is an allowable first key 921 through comparison to first key file 987, which was originally populated from vendor product database 985. If first key 921 is not in first key file 987, or is found with an attribute of “acquired”, then step 1120 advances to step 1130. If first key 921 is in legitimate first key file 987 without an attribute of “acquired”, then method 1100 advances to step 1125.

In one embodiment, in step 1125, it is determined if first key 921 is received from an authorized reseller within a permitted geopolitical region. This is performed by comparing an identification number associated with terminal 925 with legitimate retail outlet file 989, and, when required, using the first key to derive the legitimate geographical or geopolitical region for which the product is intended, and comparing it to the location of the retail outlet. If terminal 925 is associated with an authorized reseller that is properly located for the product, step 1125 advances to step 1135. Otherwise, step 1125 advances to step 1130.

In step 1130, in one embodiment, the sales transaction is denied. Method 1100 then ends. In another embodiment, in step 1130, product 919 is allowed to be taken from the store with (i) no payment, (ii) a nominal payment, or (iii) full payment. The “no payment” or “nominal payment” options match with subsequent online installation options, in which installation is permitted after online payment (e.g., through credit or debit cards/accounts).

The “full-payment” option updates KMS 970 with the first key read from the product/package, and enables installation with a newly generated second key delivered from KMS 980 to printer 937 (as process 1100 jumps to steps 1135 and 1140). The newly generated second key will be honored by KMS 970 upon the first instance of subsequent online installation, since its use supersedes the required match with the original encrypted second key 922e that may have been encoded in the product. This method may be used as another preferred embodiment, in which there is no need to encode a unique second key in the product, or to match the instance of the product with its package (product type matching is still required); however, this method must only be used with online installation in order to block the propagation of generic second keys for the product.

The “nominal payment” or “no payment” options of step 1130 are determined by the vendor's and/or retailer's business model; they enable the remuneration of the retailer for distributing copies of the products to customers who may choose to pay for the product upon subsequent installation; for these copies of the product, the subsequent installation can be performed by anyone, not necessarily the original in-store customer. In all cases, the process continues with steps 1135 and 1140, with the attribute of “acquired but unpaid” (extending the attribute range of 991) attached to the resulting transaction. “Acquired but unpaid” (not shown in FIG. 9) enables the recording of the retail transaction so that subsequent payment is demanded upon installation, and so that credit is then given to the retail outlet if determined by the business model used.

All such transactions (no payment, nominal payment, or full payment) are reported by KMS 970 to VPD 985. In an alternative embodiment, it is VPD 985 that generates the second keys in real time at the request of KMS 970; in this manner, the vendor maintains control of all keys.

In step 1135, an acknowledgement of the sale is sent to the retailer via the controller of terminal 925; the acknowledgment indicates that the sale is acceptable to KMS 970 as determined through accessing first key file 987 and checking its attributes; the attributes of that first key is then changed to “acquired”, and method 1100 advances to step 1140.

In step 1140, second key 922, associated with product 919 by the vendor, is sent from second key file 998 to printer 937, enabling the customer to subsequently use it, if desired, to enable the operation of product 919 while offline. This second key can be, for instance, printed as part of the credit/debit card receipt or on a separate slip that may be attachable (e.g., a sticky label) to package 905. Method 1400 then stops.

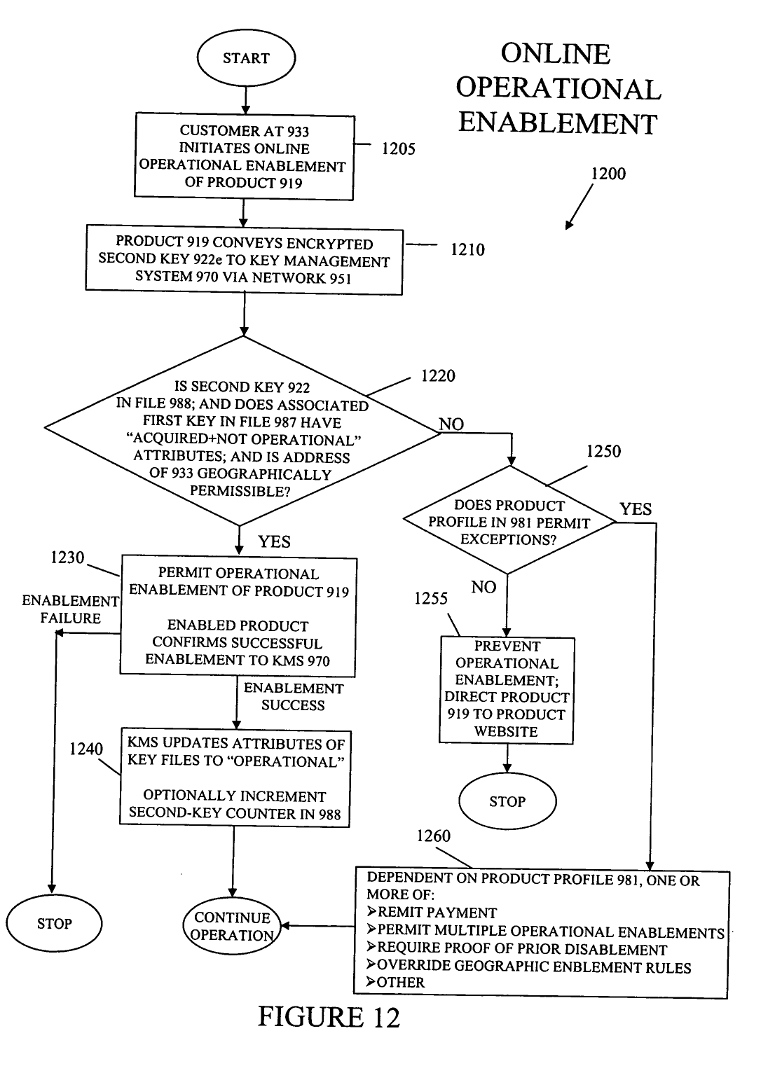

FIG. 12 illustrates a method 1200 for enabling the operation of product 919 over the Internet. Generally, method 1200 determines whether the key attributes 995, received by PRD 980 during installation/operational enablement, indicate “acquired” 991 and “not operational” 992

In step 1205, customer begins to operationally enable product 919 (on a target device, such as a home PC, or on a self-contained product). The person who installs product 919 is not necessarily the purchaser; the term “purchaser” is limited to the person who purchases the product in the retail environment, whereas the “customer” is the user of the product. Step 1205 advances to step 1210.

In step 1210, the product 919, during the initiation of the operational-enablement process, conveys the encoded, encrypted second key 922e to KMS 970. Step 1210 advances to step 520.

In step 1220, KMS 970 determines if received, decrypted second key 922 is found in second key file 988, and if its attributes are “acquired” and “not operational”. Optionally, KMS 970 also determines if operational enablement is attempted from a geographic or geo-political boundary specified in product profile 981. If these conditions are not met, step 1220 advances to step 1250; if the conditions are met, then step 1220 advances to step 1230.

In step 1230, permission is granted by KMS 970 to activate product 919. Upon successful operational enablement (as reported by the operational product), step 1230 advances to step 1240. Where operational enablement success is not reported, method 1200 ends; since this ending results in no state change in KMS 970, the operational enablement attempt can be repeated later; in an alternative embodiment, each unsuccessful operational enablement increments a counter in Databases 980 for downstream customer-care use.

In step 1240, upon successful operational enablement, the operational product sends a “successfully enabled” message to KMS 970. KMS then updates key attributes 995 to “operational”, and the customer is prompted to register the software with the vendor and/or the KMS. In an alternative embodiment, KMS 970 increments second key 988 in preparation of multiple-seat product activation when so defined in product profile 081. Method 1200 then ends while permitting product operation to continue.

In step 1250, KMS 1250 uses second key 922 to check product profile 981 to determine whether exceptions (originally defined by the product vendor) are permitted. If none in permitted, step 1250 proceeds to step 1250. If exceptions are permitted, step 1250 proceeds to step 1260.

In step 1250, KMS 970 denies permission for operationally enabling product 919, and method 1200 ends.

Step 1260 handles alternatives to denials of operational enablement permission. If product profile 981 so permits, one or more of the following options is made available to the installer-customer: (i) the customer is prompted to submit payment, and KMS 970 permits operational enablement upon confirmation of such via steps 1230 and 1240. (ii) The profile indicates that multiple operational enablements (e.g., multiple-seat software installation & use) are permitted; KMS 970 prompts the product to send the next encrypted second key 922e embedded in the product, and the operational enablement is allowed to proceed via steps 1230 and 1240. (iii) The customer is prompted for proof of product that the product had been disabled (e.g., that a software product had been uninstalled), and the new operational enablement is permitted following receipt of such proof. (iv) The geographic operational activation rules are expanded for this case. (v) Other exceptions (e.g., temporary demos, software rental . . . ) as defined in product profile 981. Step 1260 then proceeds to end method 1200 while permitting product operation to continue.

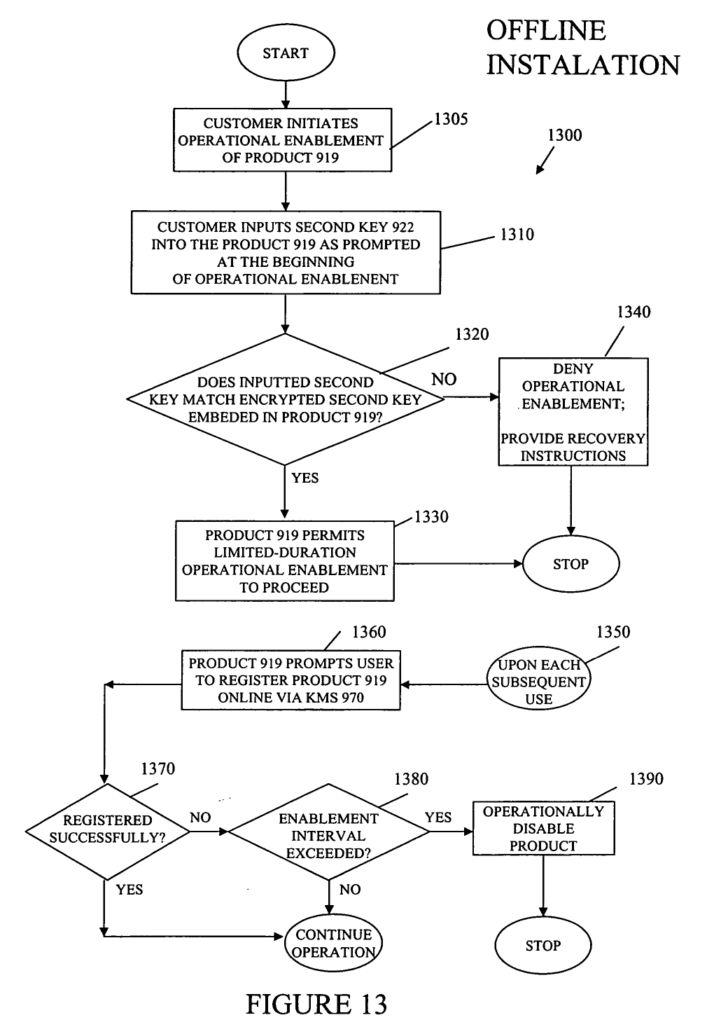

FIG. 13 illustrates a method 1300 for activating product 919 while the customer is not connected to means for real-time communications with KMS 970 (e.g., network 951). Generally, method 1300 seeks a confirmation of the validity of second key 922 to activate product 919.

In step 1305, the customer initiates the offline operational enablement of product 919; one example is the offline installation of a software product on a target device, such as a home PC. Step 1305 advances to step 1310.

In step 1310, customer inputs second key 922 into product 919, or into the target device (e.g., PC) into which the customer wishes to install software product 919. Method 1300 advances to step 1320.

In step 1320, product 919 determines whether the inputted second key matches second key 922e that is encrypted and embedded within product 919. If the keys match, method 1300 advances to step 1330. Otherwise, method 1300 advances to step 1340.

In step 1330, product 919 is operationally enabled, or permitted to be installed on the target device. In one embodiment, the operation of the enabled product is limited in timeframe as designed by the product vendor within product 919. The limit ensures that product 919 is limited in the duration of use in cases where product registration is important to the vendor; this embodiment also enables product-use time-based rental (e.g., software rental). Method 1300 then stops, but step 1340 begins in each subsequent attempt to operate the product.

In step 1340, product 919 denies its own operational enablement. In one embodiment, the denial is accompanied by instructions that guide the customer through an online process enabling the interaction of product 919 with KMS 970, which may result in (i) the permanent operability of installed product 919 or (ii) the extension of period of operation by some interval, depending on conditions populated into product profiles 981 by the vendor and/or distributor. Method 1300 then stops.

Step 1350 designates that this part of method 1300 is executed whenever product 919's operation is begun during the time interval between offline operational activation until the product is registered online with KMS 970, and subsequent to that in cases of product rental. This step is not invoked when product 919 includes an exclusion freeing it from mandatory online registration. Method 1300 then proceeds to step 1350.

In step 1360, product 919 prompts the customer to connect to an appropriate network (e.g., the Internet), and, when connected, send the encrypted second key 922e to KMS 970. The process continues as in the case of online operational enablement (method 1200—FIG. 12), with the exception that regardless of the result, the method proceeds to step 1370.

Step 1370 determines whether the product was appropriately registered (with long-term installation approved—“successful”), or not (“unsuccessful”). If successful, method 1300 stops; if unsuccessful, method 1300 proceeds to step 1380.

Step 1380 compares the time since offline product enablement with the interval pre-coded into product 919. If the interval was exceeded, step 1370 moves to step 1390; if the interval has not been exceeded, product 919 informs the customer, through any available output device (e.g., screen, speaker . . . ) inherent in the product or in the target device that the operability of product 919 will terminate on a specific date unless registered online before then.

In Step 1390, the product is disabled, and recovery instructions (e.g., those in step 1340) are provided to the customer via an output device. In other embodiments, the product may continue operation beyond the deadline with some reduced functionality. Method 1300 then stops.

In another embodiment, the feature enabling the temporary operation of the installed product can be used to enable software rental. The rental interval is consulted whenever the product is nearing the end of its rental period; time increments are enabled trough online communications with KMS 970, through which incremental payments can be paid and applied toward extending the rental period, or to covert the rented product into a purchased one.

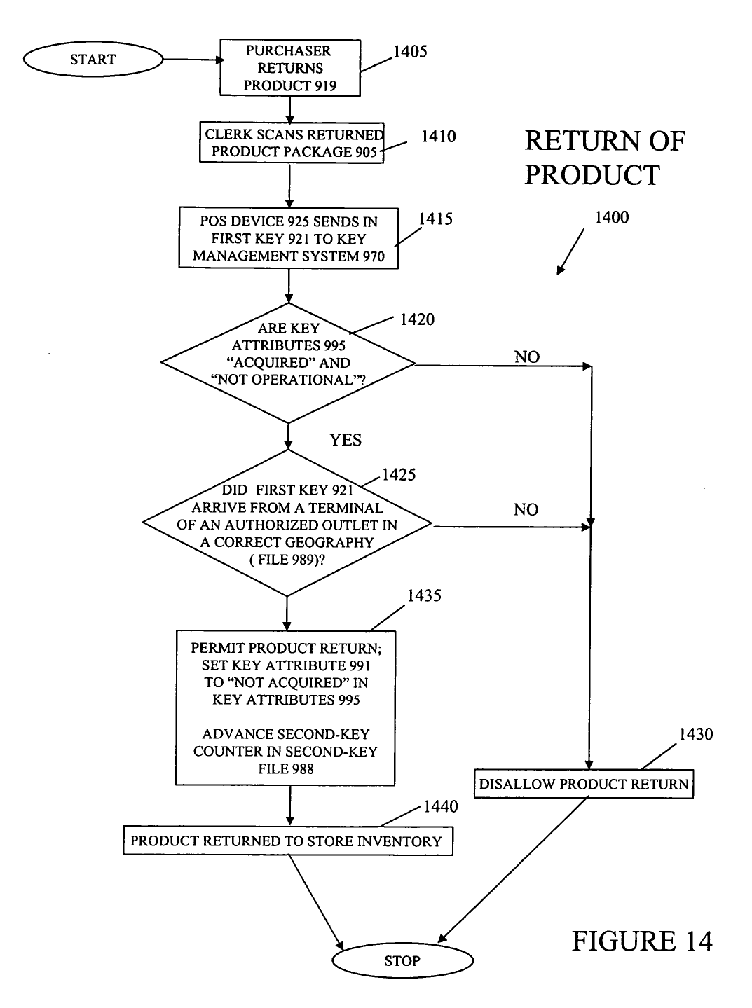

FIG. 14 depicts method 1400 enabling in-store product returns. The method starts in step 1405, when the purchaser presents the product to a store clerk for return. The method proceeds top step 1410.

In step 1410, the clerk scans the returned product package 905 at either (i) the same type of terminal 925 used to purchase such products, or (ii) a special terminal 925r used for product returns only. In case (i), the clerk must input a transaction type (“return”) indicating that this is a product return rather than a purchase. In case (ii), the designation of the return transaction is implied by the terminal ID (whose profile in 989 designates a return terminal), so that KMS 970 implies the transaction as a return. Method 1400 proceeds to step 1415.

In step 1415, point-of-sale terminal 925 sends first key 921 to KMS 970, with an explicit or implied designation of “return transaction”. Method 1400 proceeds with step 1420.

In step 1420, KMS 970 checks the product's key attributes. If the attributes are “acquired” and “not operational”, then method 1400 continues in step 1425; otherwise, method 1400 continues in step 1430.

In step 1425, KMS checks to ensure that first key 921 arrived from a terminal in an authorized merchant's facility; optionally, KMS 970 also checks that the product is returned within a correct geographical boundary (as specified in product profile 981. If the conditions are not met, method 1400 continues in step 1430. If the conditions are met, method 1400 continues in step 1435. In another embodiment, KMS 970 also checks to determine that the returned product was originally bought within the specific store to which it is returned, and denies such return depending on store, distributor, or vendor rules stored in product profiles 981, other databases (not shown) may also be consulted; for example, returns might be conditioned on the original purchase having taken place in the same geographical region as that of the outlet in which it is returned. In another embodiment, KMS 970 also checks the interval between the date of original purchase, and the date of attempted return; KMS 970 then permits or denies the return based on vendor, distributor, or store policy stored in product profile 981; other databases (not shown) may also be consulted.

In step 1430, KMS 970 disallows the return of product 919. The retail outlet may accept the return without KMS approval, but must then dispose of the product. In another embodiment, the store may give the disallowed, returned product away to some other customer (without a copy of the second key 922); the latter customer would be encouraged to purchase the product upon installation attempt, as describer in association with FIG. 12. Method 1400 then stops.

In step 1435, KMS 970 permits (by indication through terminal 925) the product's return, and sets the product's key attribute 995 to “not acquired”. In one embodiment, KMS 970 then increments a second-key 922 counter to point at the second key to be associated with the first key 921 next time the product is sold to a person. This embodiment may require multiple encrypted second keys 922e(s) to be embedded into (e.g., the media of) product 919 (and multiple second keys 922 to populate second key file 988 in association with each first key 921), thus ensuring that the person who returned the product did not copy the software with the intent to install it after the return process is complete. Method 1400 proceeds to step 1440.

In step 1440, the returned product is put back into store inventory for future sale, and method 1400 stops.

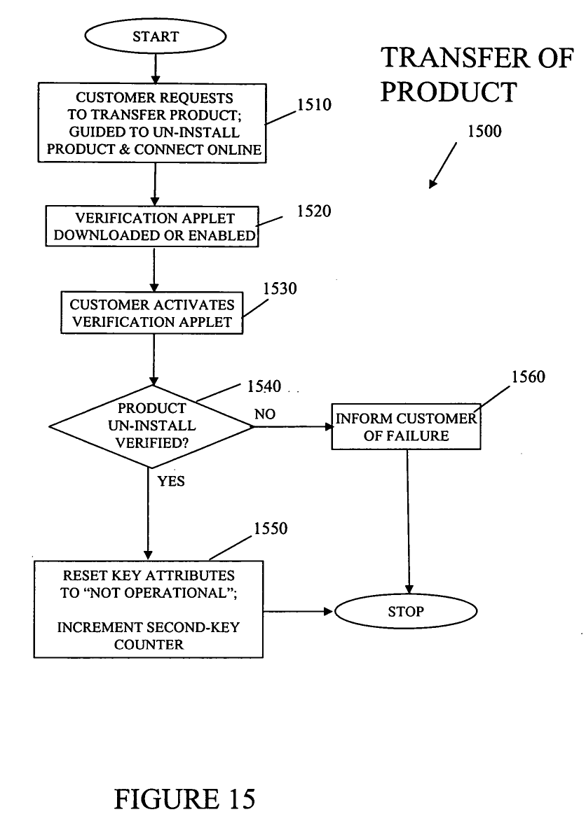

FIG. 15 depicts method 1500, which enables the authorized transfer of software or media among target devices, whether owned by the original customer or not. An analogous embodiment may be used for transferring other types of products among users in cases where the license to use the product limits its use to only one owner-environment at a time, where such products have intelligence and are network connectable. The customer may communicate with a customer-service facility, as needed, to assist in one or more aspects of this method.

Method 1500 starts with step 1510, in which the customer requests permission to transfer the product (e.g., software) to another person and/or device. This request is conditional on product profile entries permitting such transfer within the purchase agreement, and can be made through a web page or directly through installed product 919 while the customer is online. The product addresses the request to KMS 970, which uses second key 922e (received with the request) to identify the specific product instance. Method 1500 advances to step 1520.

In step 1520, an uninstallation-verification applet is downloaded to the target device, and the customer is instructed to uninstall product 919 from the target device. Method 1500 continues in step 1530. Where the product is self contained, including appropriate processing and network connectivity features, “uninstallation” may be replaced by “product deactivation”, as may be the case, e.g., where sequential generations of products are marketed so as to provide price advantage for product loyalty.

In step 1530, the customer uninstall the product from the target device (or otherwise disables the product's operation), and activates the un-installation-verification applet. Method 1500 continues in step 1540

In step 1540, the applet verifies whether the product was truly uninstalled. If uninstallation is verified, method 1500 continues to step 1550. If uninstallation cannot be verifies, method 1500 proceeds to step 1560.

In step 1550, KMS receives the indication that the product was successfully uninstalled, and resets the key attribute for the specific product instance to “not installed”. The product can now be installed on another online target device in the usual manner as described in FIG. 12 by any customer (including the original customer); this enables the transfer of the product among devices, and among subsequent users (e.g., enabling resale through eBay). In one embodiment, the second-key pointer in 988 is incremented, thus enabling the control of the number of re-installations/re-sales in accordance with product profile 981 as originally dictated by the product vendor through database 985. The latter embodiment requires that multiple encrypted second keys 922e have been embedded into product 919, and pre-populated in second-key file 988. Method 1500 then stops.

In step 1560, the customer is informed that verification of uninstallation failed, and provided a process (e.g., online FAQ and customer help) for optional follow-through. Method 1500 then stops.

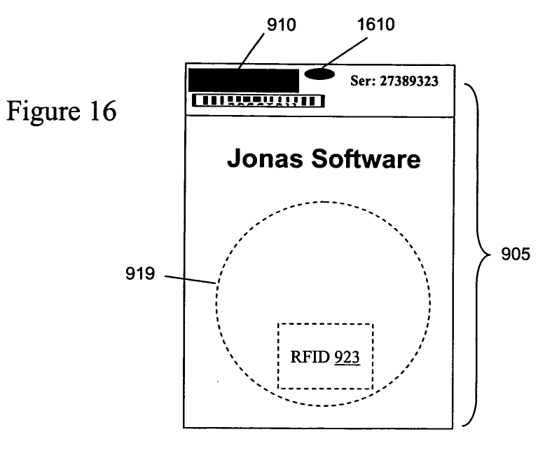

FIG. 16 is an illustration of a product 919 in a package 905; the package 905 has a thin tab containing a magnetic strip and one or more identification numbers. The thin tab is designed so that it can be swiped by a store clerk through a magnetic-stripe reader commonly used for swiping credit or debit cards. The identification numbers include a standard UPC code, and a serial number. The UPC code and the serial number are preferably provided in machine-readable (e.g., optical) format, which is also readable by store clerks in case a local reading device is not available. The magnetic stripe and the serial number are coded with the at least first key 921. The package 905 may also include an RFID, which is encoded with the first key 921; in a preferred embodiment, the RFID is attached to (or is an integral part of) product 919 rather than to package 905. In another embodiment, RFID 923 also includes all the codes a retail store requires to check out product 919. The product package contains means (e.g., a hole) 1510 for hanging multiple product packages 905 on a retail display rack; this feature is enabled by the reduction/flattening of package size, since the threat of product theft is substantially eliminated, thus enabling the display of said product outside of secure store containers.

It should be understood that various alternatives, combinations and modifications of the teachings described herein could be devised by those skilled in the art. The present invention is intended to embrace all such alternatives, modifications and variances that fall within the scope of the appended claims.

What is claimed is:

1. A method for authorizing the sale of a product to a purchaser, comprising:
sending a key from a point of sale device to a management system managing at least one key;
determining if said key is found in said management system;
determining a status of said key according to sale-authorization criteria comprising at least one factor;
authorizing the sale of the product at said point of sale device (i) if said key is found in said management system and (ii) if said status meets said sale-authorization criteria; and
providing to the purchaser an enablement key associated with said key at time of purchase.

2. The method of claim 1, wherein said sale-authorization criteria comprise at least one criteria selected from the group consisting of: (i) said point of sale device is valid for said key, (ii) said point of sale device is at a valid merchant for said key, (iii) said point of sale device is in permissible geographic or geopolitical regions for said key, (iv) said key status indicates the product was not yet sold, and (v) said key status indicates the product was not yet operationally enabled.

3. The method of claim 1, wherein said enablement key is used for the operational enablement of the product.

4. The product produced by said method of claim 1.

5. A method of manufacturing a product in a package, comprising:
generating a key;
generating an associated enablement key;
sending a copy of said key and said enablement key to a key management system;
placing a copy of said key on said package; and
encrypting and embedding a copy of said associated enablement key in the product.

6. The method of claim 5, further comprising embedding in said product a means for communicating with said key management system through a network.

7. The method of claim 6, further comprising embedding in said product a means for providing to said key management system said copy of embedded encrypted enablement key.

8. The method of claim 5, further comprising embedding in said product a means for enabling said product operation based on (i) communication with said key management system, and/or (ii) local entry of said enablement key, wherein local entry comprises at least one selected from the group consisting of: manual entry; voice entry; and entry from media connected to said product using wired or wireless connectivity.

9. The method of claim 5, further comprising placing said copy of said key so that said key is readable by at least one selected from the group consisting of: a point of sale device; a person; and a person assisted by a device.

10. A system for authorizing an online operational enablement of a product through employment of a key management system, comprising;
a database having a key file and an enablement key file;
a backend system with means for reading an enablement key embedded in said product during an online operational enablement session, wherein said backend system searches for said embedded enablement key in said enablement key file and denies said operational enablement if said embedded enablement key is not found in said enablement key file;
wherein said key file further comprises:
an acquired attribute; and
an enabled attribute;
wherein said backend system denies said operational enablement if said acquired attribute is set for negative for said key;
wherein said backend system denies said operational enablement if said enabled attribute is set for positive for said key,
wherein said backend system compares the said embedded enablement key to the stored enablement key that correlates to said key; and
wherein said backend system authorizes said operational enablement of said product if said stored enablement key correlates to said embedded enablement key and said backend system denies said authorization of said operational enablement of said product if said stored enablement key does not correlate to said embedded enablement key,
wherein said embedded operational key is either encrypted or not encrypted.

11. The system of claim 10, wherein said key file further comprises a geographic operational attribute;
wherein said backend system denies said operational enablement of said product if said enablement is initiated from a physical or political region different from that defined by said geographic operational attribute; and authorizes operational enablement when said physical or political region is within the permissible range as defined by said geographic operational attribute.

12. The system of claim 11, wherein said geographic operational attribute is populated from at least one data selected from the group consisting of: vendor data; distributor data; the geographic region of the authorized point of sale device; and data embedded in said product.

13. The system of claim 11, wherein the geographic region from which said operational enablement is initiated is determined from a network address.

14. A system for authorizing product activation at a point of sale comprising:
a product repository database (PRD);
a legitimate key file in said PRD; and
an input device that inputs an identifier during a sale of said product;
wherein said PRD compares said identifier with said legitimate key file to determine if said identifier is found in said legitimate key file; and
wherein said PRD designates said found key in said key file as activated if said identifier is found in said legitimate key file.

15. The system of claim 14, wherein said PRD denies said sale if said identifier is not found in said legitimate key file and/or offers to sell said identifier so that said product can be legitimately activated.

16. The system of claim 14, wherein said legitimate key file is received from at least one database selected from the group consisting of: a vendor product database; and a distributor database.

17. The system of claim 14, wherein said PRD further comprises an activated key designation.

18. The system of claim 17, wherein said PRD compares said identifier to said activated key designation for on-line activation, wherein
if said identifier in said key file is not designated as activated, said PRD activates said product; and
if said identifier is found in said activated key file, said PRD does not activate said product.

19. The system of claim 18, wherein said key is designated as activated if said key is not already so designated.

20. The system of claim 18, wherein said identifier and said key have an exact correlation.

21. The system of claim 14, wherein said product has intelligence.

22. The system of claim 21, wherein said intelligence comprises a least one selected from the group consisting of: encrypted or unencrypted version of an enablement key; a network address of said PRD; and means for communicating with said PRD.

23. The system of claim 14, wherein said input device has an associated retail outlet number.

24. The system of claim 23, wherein said PRD further determines whether said associated retail outlet number is contained in a legitimate retail outlet file.

25. The system of claim 24, wherein said PRD further determines whether said associated retail outlet number is authorized to sell the product identified with said key.

26. The system of claim 14, wherein said key is a unique key.

27. The system of claim 14, further comprising a network coupled between said input device and said PRD, wherein said network comprises at least one selected from the group consisting of: packet-switched network; circuit-switched network; private line; an IP network; and wired or wireless transmission media.

28. The system of claim 14, wherein a packaging of said product has an associated magnetic strip readable by said input device, wherein said key is contained within said associated magnetic strip.

29. The system of claim 23, wherein said input device is a credit card reading machine.

30. The system of claim 23, further comprising a radio frequency identifier (RFID) embedded in or on said product, wherein said RFID contains at least said key.

31. The system of claim 23, wherein said PRD enables the operation of said product based on said product intelligence when said product is online.

32. The system of claim 23, wherein a purchaser receives a copy of said enablement key at time of purchase.

33. The system of claim 32, wherein said purchaser inputs said copy of said enablement key to enable operation of said product when said product or a target device for said product is offline.

34. A method for authorizing an off-line operational enablement of a product comprising:
receiving a key, which is either encrypted or non-encrypted, from a product repository database (PRD) at time of purchase;
initializing an operational enablement of said product;
inputting said key using said product;
determining if said key matches against a product-embedded key; and
if said key matches against said product-embedded key, enabling the operation of said product.

35. The method of claim 34, wherein said operational enablement is performed once for all subsequent product operations.

36. The method of claim 35, further comprising checking an identifier key against a legitimate identifier key file before permitting said receiving step to proceed.

37. The method of claim 35, wherein said product comprises a device carrying content, wherein said device is selected from the group consisting of: DVD, CD, and flash memory, and said key enables said device to perform at least one function selected from the group consisting of: a fixed number of uses, a fixed amount of time, and unlimited use.

38. The method of claim 35, wherein at least one of said key and product-embedded key is a unique key.

39. A method of manufacturing a product, comprising:
determining whether a key is to be embedded in the product and/or in the packaging of said product;
embedding a device having said key if said key is to be embedded in said product;
programming said key on a magnetic strip portion of the package, and/or into a device disposed in or on said package if said key is to be embedded in said packaging;
sending a copy of said key to a legitimate key file;
generating an enablement key;
sending a copy of said enablement key to an enablement key file with association to said key; and
encrypting and embedding said enablement key in said product.

40. The method of claim 39, further comprising embedding the network address of a product enablement database in said product.

41. The method of claim 39, wherein said programming step further comprises printing said key so that said key can be optically read by at least one selected from the group consisting of:
a point of sale device, and
a human,
when said product is in said package.

42. A method for manufacturing a product having two factor authentication, said method comprising:
generating a key and an enablement key;
encrypting said enablement key;
embedding said encrypted enablement key into said product;
printing said key and/or encoding a magnetic strip and/or programming an RFID and attaching to at least one of
package intended for said product, or said product itself;
sending said key and said enablement key to a key management system;
initializing key attributes as “not acquired” and “not enabled”;
populating legitimate merchant identification and/or permissible product selling geography; and
inserting said product with said key and/or enablement key into said package.

43. A method for purchasing a product comprising:
sending a key disposed in and/or on said product or a packaging of said product to a key management system to determine if said key in said key management system has a key attribute of “not acquired”;
if said key attribute is “acquired”, denying retail transaction;
if said key attribute is “not acquired”, determining if said key arrived from a terminal of an authorized outlet in a correct geography;
if authorized outlet is not in a correct geography, denying retail transaction; and
if authorized outlet is in a correct geography, permitting said retail transaction and resetting key attribute to “acquired”.

44. The method according to claim 43, further comprising:
providing a purchaser of said product during said permitted retail transaction with an enablement key, wherein said enablement key enables the operation of said product when said product is not communicating to said key management system

45. A method for online installation of a product having a key and an installation key, said method comprising:
initiating said installation of said product on a target device;
communicating an encrypted installation key disposed on or about said product to a key management system comprising a key file and an installation-key file;
determining if said installation key is listed in said installation-key file;
determining if said key is listed in said key file and if said key file indicates that said key comprises an “acquired” attribute and an “uninstalled” attribute; and
permitting installation of said product on said target device if said key comprises said “acquired” attribute and said “uninstalled” attribute or preventing installation of said product on said target device if said key does not comprise either said “acquired” attribute or said “uninstalled” attribute.

46. The method according to claim 45, further comprising the step of:
if installation is permitted, updating said key management system such that said key acquires an “installed” attribute.

47. The method according to claim 45, further comprising the step of:
if said installation key is not listed in said installation-key file or if said key does not comprise either said “acquired” attribute or said “uninstalled” attribute, determining if a product profile permits exceptions;
if no exceptions are permitted in said product profile, preventing installation of said product on said target device; or
if exceptions are permitted in said product profile, permitting at least one action selected from the group comprising: remitting of payment to permit installation of said product on said target device; permitting installation of said product on a plurality of target devices; and requiring proof of prior uninstallation to permit installation of said product on said target device to proceed.

48. A method for offline installation of a product on a target device, said method comprising:
inputting an installation key into said target device;
determining if said inputted installation key corresponds to a previously encrypted installation key embedded in said product; and
if inputted installation key does not correspond to said encrypted installation key, denying installation of said product on said target device; or
if inputted installation key does correspond to said encrypted installation key, permitting limited-duration operation of said product on said target device.

49. The method of claim 48, further comprises:
when said product operates on said target device,
determining if said limited duration is in effect;
if said limited duration is in effect, continuing operation of said product on said target device;
if said limited duration nears expiration within a defined interval, perform one of the following steps; nothing, or alerting user to connect said target device online and register said product with said key management system;
if said limited duration expired, causing at least one action selected from:
disabling further operation of said product on said target device;
connecting of target device online and registering said product; and
remitting of payment to permit continued operation of said product on said target device.

50. The method of claim 49, wherein said registration may result in extension of said limited duration by an incremental interval, or in the elimination of said limited duration test.

51. A method of returning a product to a retailer comprising:
scanning said product to determine if a key is present;
communicating said key to a key management system;
determining if said key management system includes attributes of said key comprising “acquired” attribute and “not activated” attribute;
if either of said key attributes are not present, disallowing return of said product;
if both key attributes are present, determining if said key was communicated from an authorized point of sale;
if said key was not communicated from an authorized point of sale, disallowing return of said product; and
if said key was communicated from an authorized point of sale, permitting return of said product.

52. The method of claim 51, wherein said permitting of return further ensures at least one condition selected from the group consisting of: that said key was communicated from an authorized point of sale within the same retail outlet from which the original purchase was made, that the return is attempted at an outlet of the same retail chain from which the original purchase was made, and that the return is attempted at a retail outlet within geographic boundaries authorized for selling said returned product; and disallowing return of said product if at least one condition is not met.

53. The method according to claim 52, further comprising:
after permitted return of said product, resetting key attribute of said first key to a “not acquired” attribute; and
returning said product to inventory.

54. A method of transferring an installed product comprising:
requesting that said installed product be uninstalled;
downloading or enabling uninstallation verification means;
uninstalling said product and activating said verification means;
verifying that said product has been uninstalled; and
if uninstalling cannot be verified, informing user of failure of uninstallation; or
if uninstalling is verified, resetting a key attribute to “not installed” attribute.

55. The method of claim 54 wherein said uninstallation verification means is a program or an applet.

56. A computer readable storage media comprising executable computer program instructions which when executed cause a processing system to perform a method for authorizing an off-line operational enablement of a product comprising:
receiving a key, which is either encrypted or non-encrypted, from a product repository database (PRD) at time of purchase;
initializing an operational enablement of said product;
inputting said key using said product;
determining if said key matches against a product-embedded key; and
if said key matches against said product-embedded key, enabling the operation of said product.

57. A computer readable storage media comprising executable computer program instructions which when executed cause a processing system to perform a method of returning a product to a retailer comprising:
scanning said product to determine if a key is present;
communicating said key to a key management system;
determining if said key management system includes attributes of said key comprising “acquired” attribute and “not activated” attribute;
if either of said key attributes are not present, disallowing return of said product;
if both key attributes are present, determining if said key was communicated from an authorized point of sale;
if said key was not communicated from an authorized point of sale, disallowing return of said product; and
if said key was communicated from an authorized point of sale, permitting return of said product.

58. A computer readable storage media comprising executable computer program instructions which when executed cause a processing system to perform a method of transferring an installed product comprising:
requesting that said installed product be uninstalled;
downloading or enabling uninstallation verification means;
uninstalling said product and activating said verification means;
verifying that said product has been uninstalled; and
if uninstalling cannot be verified, informing user of failure of uninstallation; or
if uninstalling is verified, resetting a key attribute to “not installed” attribute.

59. The method of claim 37, wherein said key further enables said device to be used in at one or more target devices selected from a group consisting of one target device; a specified number of target devices; an unlimited number of target devices; and target devices of specific types.
